(19) United States
(12) Patent Application Publication
(10) Pub. No.: US 2007/0100885 A1
(43) Pub. Date: May 3, 2007

(54) Clinical trial information processing system and method

(75) Inventors: Shigeo Sumino, Fuchu (JP); Masakazu Fujio, Tokyo (JP); Yoshiki Niwa, Hatoyama (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/346,308

(22) Filed: Feb. 3, 2006

(30) Foreign Application Priority Data
Oct. 27, 2005 (JP) 2005-312102

(51) Int. Cl. G06F 17/00

(52) U.S. Cl. 707/104.1

(57) ABSTRACT

A system functioning between the clinical trial facility (trial site) and the party requesting clinical trial (sponsor) to make clinical trial more efficient. Information relating to the sponsor and information relating to the trial site, and trial basic information including the trial target disease name, the total length of trial (trial period), total number of cases and total budget registered by the sponsor, and trial contract conditions including the trial name, trial period, number of cases and budget are stored in a clinical trial database; and the process and information service unit distributes information on trial contract conditions registered in the contract information storage area to the trial site, registers applicant trial sites for trial relating to the distributed trial contract conditions, and distributes the status of applicant responses for trial contract conditions, to the trial sponsor who registered matching contract conditions.

### CLAIM OF PRIORITY

The present application claims priority from Japanese application JP 2005-312102 filed on Oct. 27, 2005, the content of which is hereby incorporated by reference into this application.

### FIELD OF THE INVENTION

The present invention relates to a system to support establishing contracts binding the facility or site performing clinical trials such as the hospital, with the sponsor requesting a clinical trial such as a pharmaceutical company.

### BACKGROUND OF THE INVENTION

A pharmaceutical company who develops a pharmaceutical that renders pharmacodynamic effects is required by law to obtain the prior approval and certification of the Ministry of Health before using that drug at medical facilities such as hospitals or selling it at drugstores. To obtain that certification the safety and effectiveness (potency) of that drug must be confirmed by administering that yet uncertified drug to actual patients and to healthy volunteers. The testing and investigation of this newly developed drug is called a clinical trial.

The main problem in clinical trials is that finding participants (trial subjects) is difficult. Speedily obtaining trial subjects is a matter of critical importance to the pharmaceutical companies in terms of development costs for the new drug. The concept called the trial subject panel is one solution for obtaining participants (trial subjects). This trial subject panel is a list made by registering volunteers in advance as potential trial subjects. In Europe and the US this trial subject panel is called a volunteer database (hereon also called volunteer database). This volunteer database is generally formed from introductions from people who participated in other clinical trials, information from physical examinations, introductions from other medical facilities, and introductions from patients, etc. In most cases these are medical facility volunteer databases.

If a volunteer database is available, the medical facility can efficiently recruit participants when a request for a clinical trial arrives since a trial subject list can be formed by referring to that same volunteer database. Moreover, if the drug is administered to the participant (hereafter called trial subject) immediately after the clinical trial request, then the time that administering the drug automatically ends is clearly known so administering the drug can end in a short time.

The contract between the sponsor and the site for the clinical trial is established by determining the number of cases indicating how many trial subjects will be used, the trial period indicating when the clinical trial will end, and the clinical trial expenses the sponsor will pay the clinical trial site. Generally, the clinical trial expenses are handled in case unit costs found by dividing the trial expenses by the number of cases.

[Patent document 1] JP-A No. 41657/2002

### SUMMARY OF THE INVENTION

The effect obtained from utilizing the volunteer database was described above, however there are few medical facilities (hereafter trial sites) actually using them. Moreover the pharmaceutical company (hereafter called sponsor) requesting the site to make a clinical trial had no choice but to enter into a contract while the trial site had only a rough idea of the number of cases. A contract was established by the sponsor visiting the trial site so that the trial site was unable to select clinical trials on its own. Also, the same case units were utilized regardless of whether the clinical trial period was long or short so the doctors in charge of the trials showed a trend to be positive about the trials in their final period rather than their initial period.

In view of the above problems with these types of clinical trials, this invention has the object of providing a clinical trial information processing system and clinical trial information processing method capable of functioning between the sponsor and trial site to make the clinical trial more efficient.

The clinical trial information processing system of this invention includes a means for establishing contract conditions including the number of cases, the completion period, the case unit costs, a means for disclosing those same contract conditions, a means for recruiting for those same contract conditions, a means for eliminating conflicts between identical contract conditions, a means for storing information to rank the trial sites, a means to rewrite that same ranking information. As one example, the clinical trial information process server of this invention stores information relating to the sponsor and information relating to the trial site, and trial basic information including the trial target disease name, the total length of trial (trial period), total number of cases and total budget registered by the sponsor, and trial contract conditions including the trial name, trial period, number of cases and budget are stored in a clinical trial database; and a process and information service unit distributes information on trial contract conditions registered in the contract condition information storage area to the trial site, registers applicant trial sites for trial relating to the distributed trial contract conditions, and distributes the status of applicant responses for trial contract conditions, to the sponsor who registered matching contract conditions.

This invention is capable of contracts where the number of cases is based on evidence in a database. The trial site can freely select the clinical trial. Moreover, the doctor can be positively motivated to perform the clinical trial from its very start since clinical trials with a high number of case units can be accepted.

### BRIEF DESCRIPTION OF THE DRAWINGS

FIG. 1 is a block diagram showing the interrelation of the related facilities of the first embodiment of this invention;

FIG. 2 is a block diagram showing the system structure for the sponsors A and B;

FIG. 3 is a block diagram showing the system structure for the clinical trial sites;

FIG. 4 is a block diagram showing the system structure of the clinical trial contract support center;

FIG. 5 is a block diagram showing the area for tables stored in the clinical trail contract support database

FIG. 6 is a drawing showing the table storing the sponsor information storage area and the trial site information storage area;

FIG. 7 is a drawing showing the table stored in the trial basic information storage area and the contract condition information storage area;

FIG. 8 is a drawing for describing the table stored in the confirmed contract information storage area and the trial results information storage area;

FIG. 9 is a drawing showing the table stored in the site rating information storage area and the trial subjects statistic information storage area;

FIG. 10 is a block diagram showing the structure of the process and information service unit;

FIG. 11 a drawing showing the interface for allowing the sponsor to register the sponsor information;

FIG. 12 is a drawing showing the interface for allowing the trial site to register trial site information;

FIG. 13 is a drawing of the interface allowing the sponsor to register the basic trial information;

FIG. 14 is a drawing of the interface allowing the sponsor to register contract condition information;

FIG. 15 is a drawing of the interface for the trial site to subscribe to the contract condition;

FIG. 16 is a drawing of the interface for allowing the sponsor to confirm the contract;

FIG. 17 is a drawing describing the interface for allowing the trial sites to register trial results information;

FIG. 18 is a drawing describing the interface for allowing the trial sites to enter trial subjects statistic information;

FIG. 19 is a drawing describing the interface for allowing the sponsor to display trial subjects statistic information;

FIG. 20 is a drawing of operation of the clinical trial contract support center shown along a time axis;

FIG. 21 is a flow chart showing the overall procedures performed by the sponsor side in the clinical trial contract support system;

FIG. 22 is a flow chart showing the procedures in the trial information registration process;

FIG. 23 is a flow chart showing the procedure for the contract confirmation process;

FIG. 24 is a flow chart showing the overall procedure in the process on the trial site side in the clinical trial contract support system;

FIG. 25 is a flow chart showing the sequence in the contract subscription process;

FIG. 26 is a block diagram showing the table area for storing the clinical trial contract support database in the second embodiment of the clinical trial contract support system of this invention;

FIG. 27 is a drawing of the table stored in the executable trial information storage area;

FIG. 28 is a block diagram showing in detail the structure of the process and information service unit of the second embodiment of this invention;

FIG. 29 is a drawing showing the interface for registering the executable trial information;

FIG. 30 is a drawing showing operation of the clinical trial contract support center along a time axis;

FIG. 31 is a flow chart showing the detailed procedure for confirming the contract; and

FIG. 32 is a detailed flow chart showing the detailed procedure for confirming the contract.

### DETAILED DESCRIPTION OF THE PREFERRED EMBODIMENTS

The multiple embodiments of the clinical trial contract support system of this invention are described next while referring to the accompanying drawings.

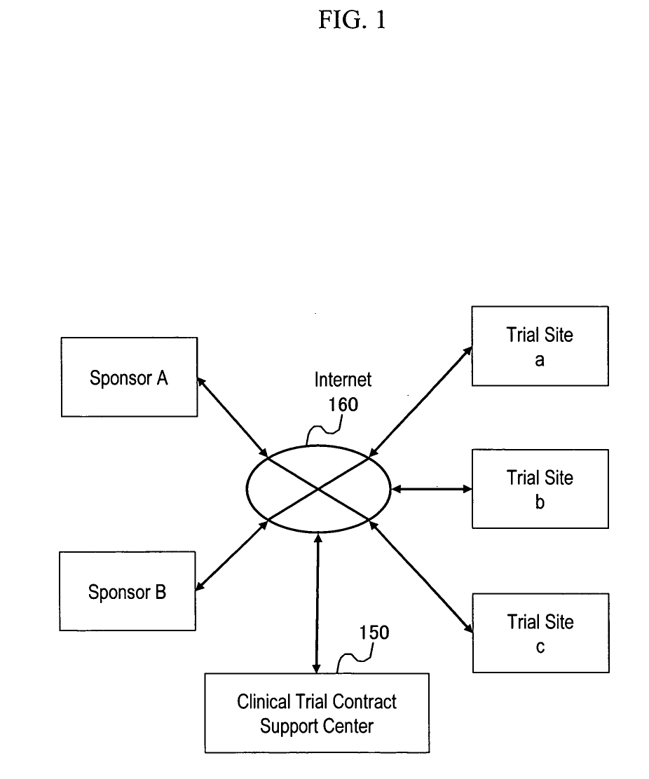

FIG. 1 is a block diagram of related clinical trial sites and facilities of the clinical trial contract support system of this invention;

In FIG. 1, sponsors A and B are for example pharmaceutical companies using the clinical trial contract support system of this invention to request a clinical trial to the trial site; the trial sites a, b, c are medical facilities commissioned to perform a clinical trial by sponsors via the clinical trial contract support system; and reference numeral 150 is a clinical trial contract support center for managing the clinical trial contract support system of this invention. The sponsor A, B and the trial sites a, b, c use the Internet 160 to access the clinical trial contract support center 150. The sponsors are not limited to two parties, and the trial sites are not limited to three parties.

In the clinical trial contract support system of this invention, the clinical trial contract support center 150 receives information relating to a request for a clinical trial from the sponsors A, B, and information relating to acceptance of a clinical trial from the trial sites a, b, c. The trial support system functions to facilitate a contract between the sponsor and trial site. Providing a clinical trial contract support center 150 to register beforehand information clinical trial information from the sponsors A and B at the center, allows each trial sites a, b, c to freely select a desired clinical trial.

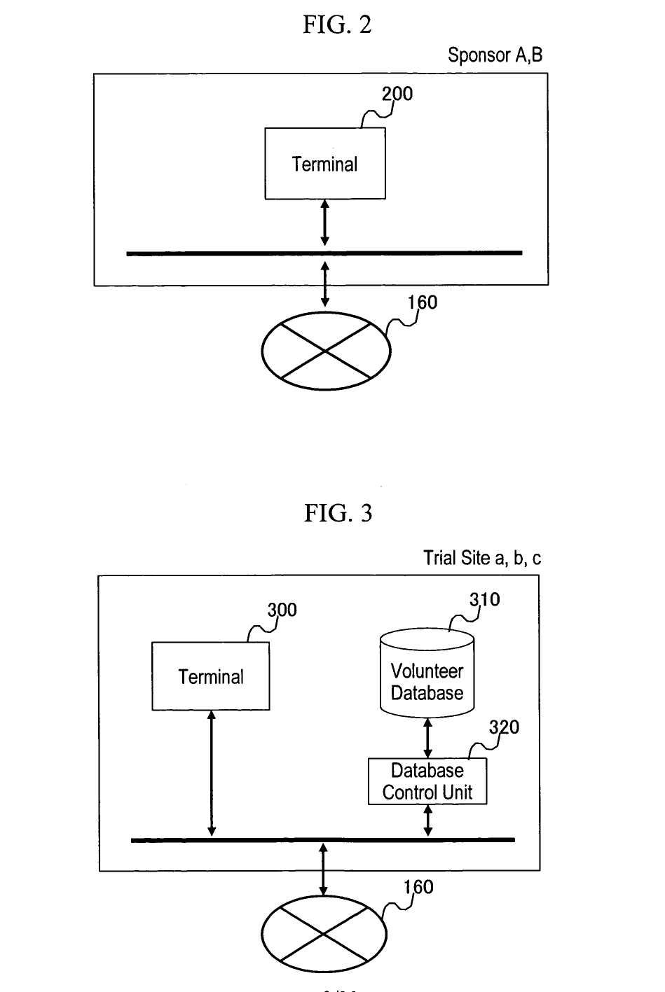

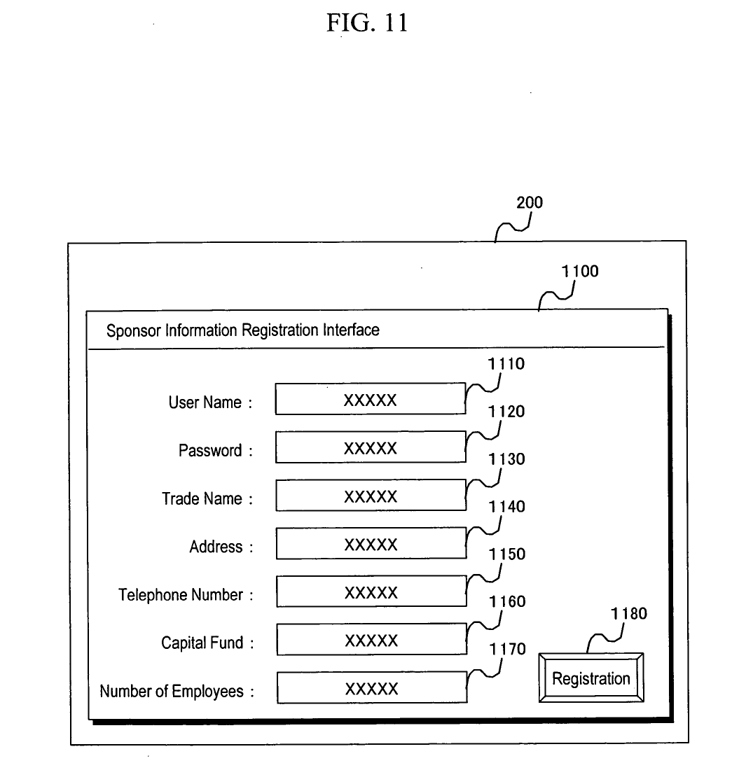

FIG. 2 is a block diagram showing the system structure for the sponsors A and B. In the figure, reference numeral 200 is a terminal for registering sponsor information, registering trail information, registering contract condition information, confirming the contract and displaying trial subjects statistical information shown in detail for sponsors A and B in FIG. 11, 13, 14, 16 and 19.

The sponsors A and B use the (input/output) terminal 200 to access via the Internet 160, the clinical trial contract support center 150 containing the clinical trial contract support system of this invention. By then registering contract conditions and information on requested clinical trials that sites a, b, c want to perform, and confirming a contract with the trial site responding to the request for a clinical trial, and displaying trial subjects statistical information, the sponsor can therefore acquire the latest information on trial sites. The sponsors A and B operate the terminal 200 to register contract conditions and trial information in advance, so that the trial sites a, b, and c can freely select a desired clinical trial to perform.

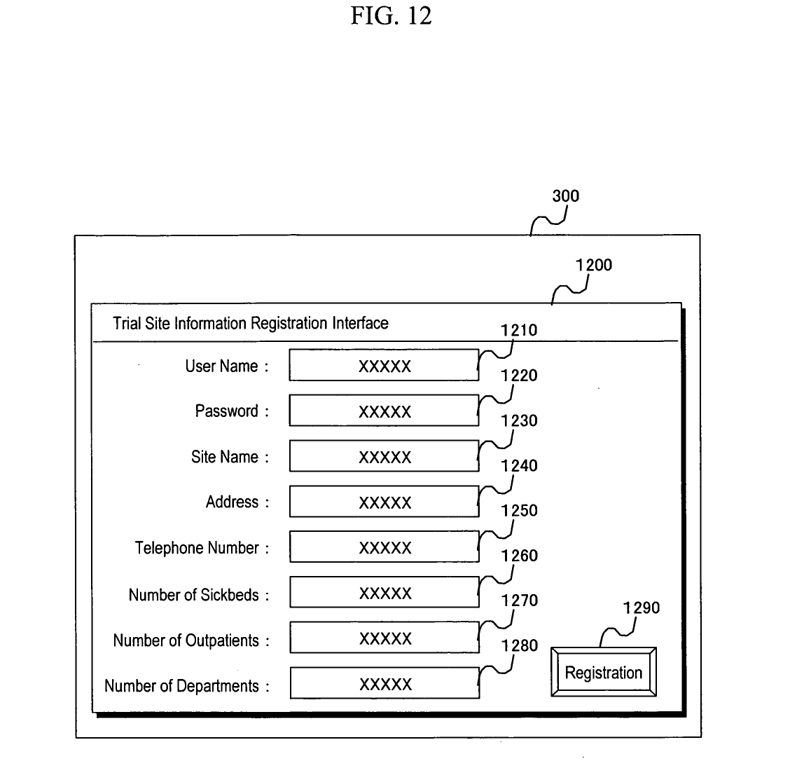

FIG. 3 is a block diagram showing the system structure for the trial sites a, b, and c. The reference numeral 300 is a terminal for registering trial site information, subscribing to a desired contract condition, registering result information on completed clinical trials, and entering trial subjects statistical information for the database as shown in detail in FIG. 12, 15, 17, and 18. The reference numeral 310 is a volunteer database storing lists of participants (trial subjects), and the reference numeral 320 is a database control unit for accessing the volunteer database 310.

The trial sites a, b, and, c within the above structure utilize the terminal 300 to access via the Internet 160, the clinical trial contract support center 150 containing the clinical trial contract support system of this invention. Information relating to the clinical trial recorded in advance by the sponsors A and B can be viewed, contract conditions can be assessed and recorded if matching the desired clinical trial, information relating to a clinical trial that was performed can be entered, and information on the number of participants (trial subjects) acquired from the volunteer database 310 can be entered. By operating the terminal 300, the clinical trial sites a, b, c, can select clinical trials and contract conditions desired by the trial sites from among the pre-registered trial site information and contract conditions.

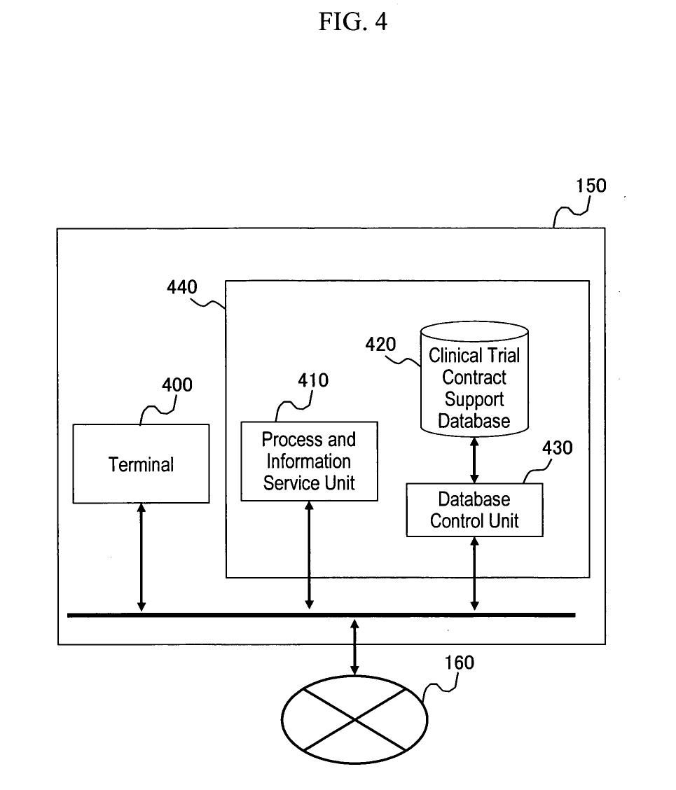

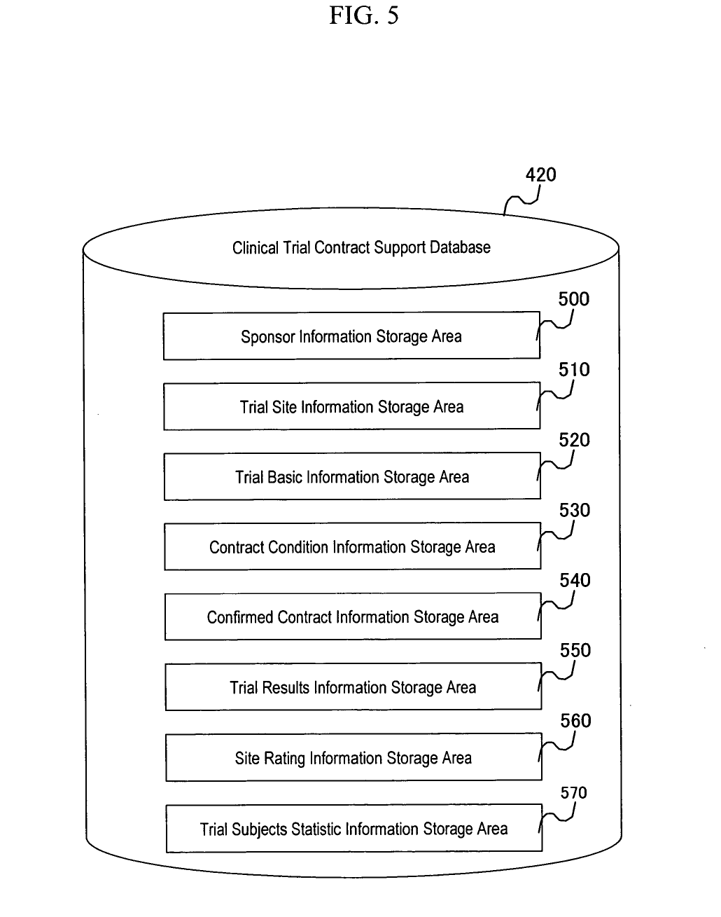

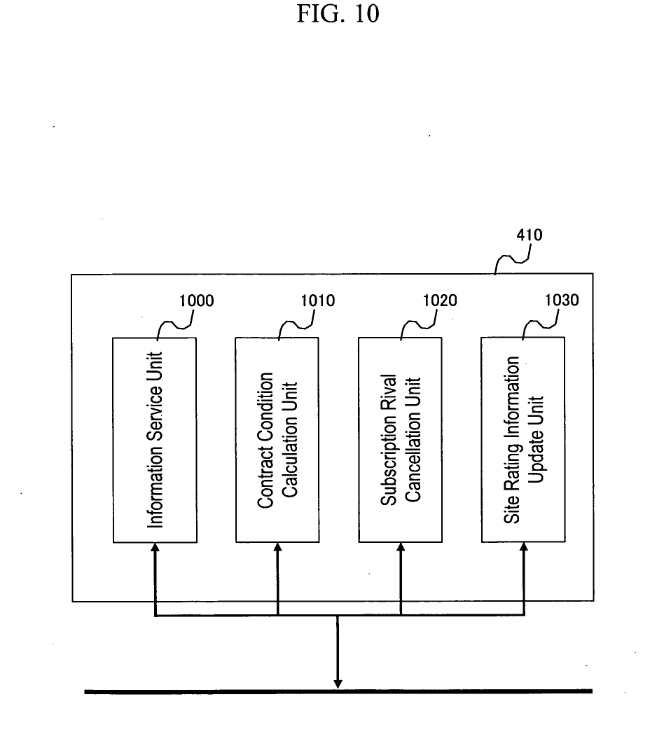

FIG. 4 is a block diagram showing the system structure of the clinical trial contract support center. The reference numeral 400 is a terminal for inputting and outputting to the clinical trial contract support system. The reference numeral 410 is a process and information service unit for main control of the clinical trial contract support system. The reference numeral 420 is a clinical trial contract support database for managing the data of the clinical trial contract support system. The reference numeral 430 is the database control unit for accessing the clinical trial contract support database 420. The reference numeral 440 is the clinical trial contract support system of this invention. The process and information service unit 410 and the clinical trial contract support database 420 are described in detail using FIG. 5 and FIG. 10.

The sponsors A, B and the trial sites, a, b and c access the clinical trial contract support system 440 over the Internet 160. In the clinical trial contract support system 440, the process and information service unit 410 controls the access processing, and exchanges information with the clinical trial contract support database 420 via the database control unit 430. The clinical trial contract support system uses the process and information service unit 410 to process information relating to clinical trials input from the terminal 300 by trial sites a, b, c and from the terminals 200 of the sponsors A and B,; and stores the clinical trial contract support data in the database 420 to allow smoothly forming contracts between the sponsors A and B and the trial sites a, b, c.

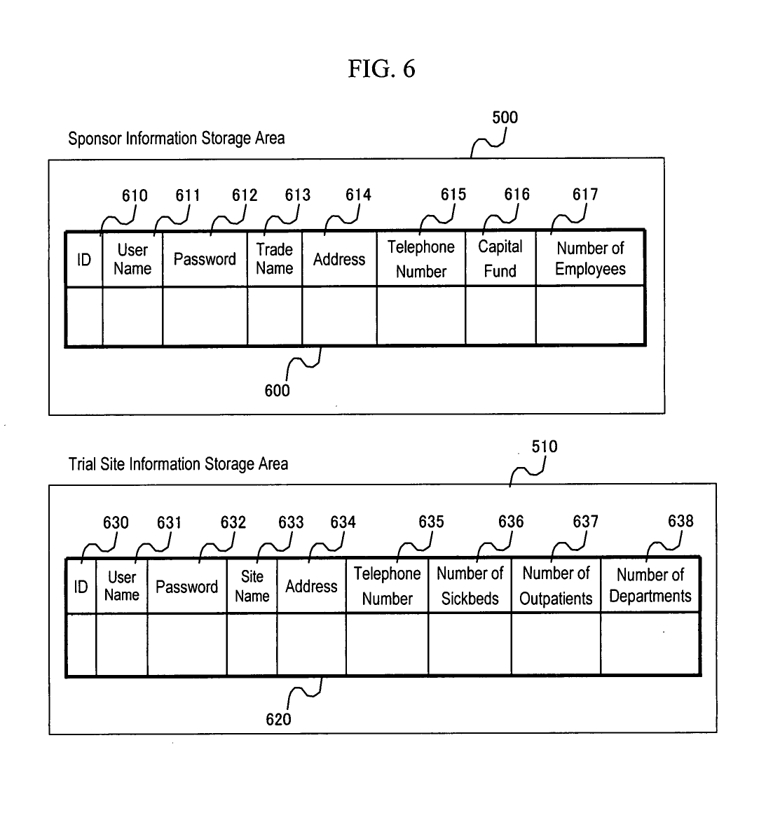

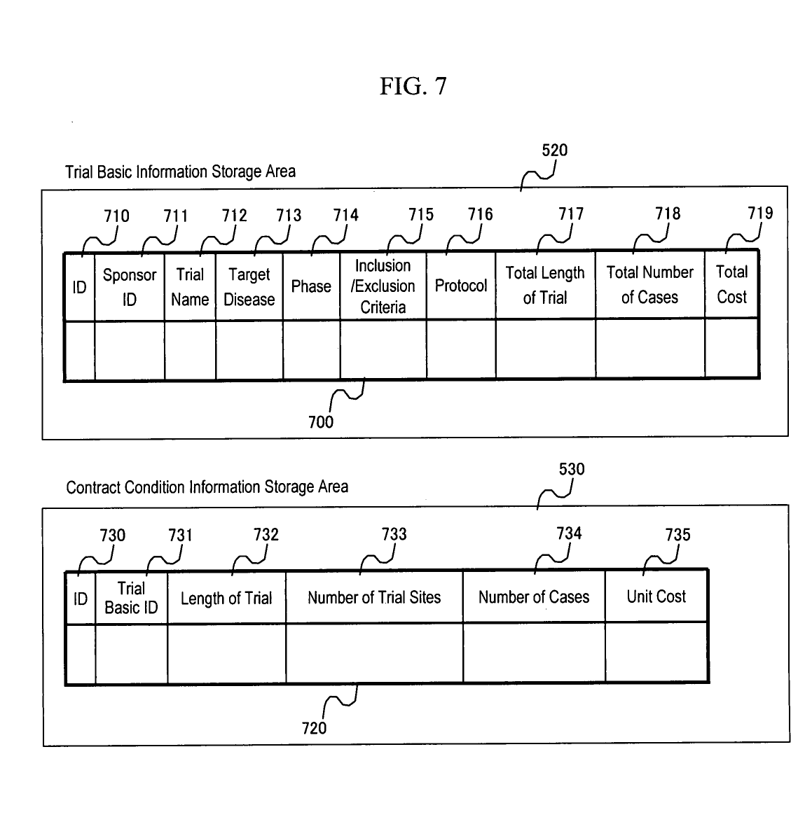

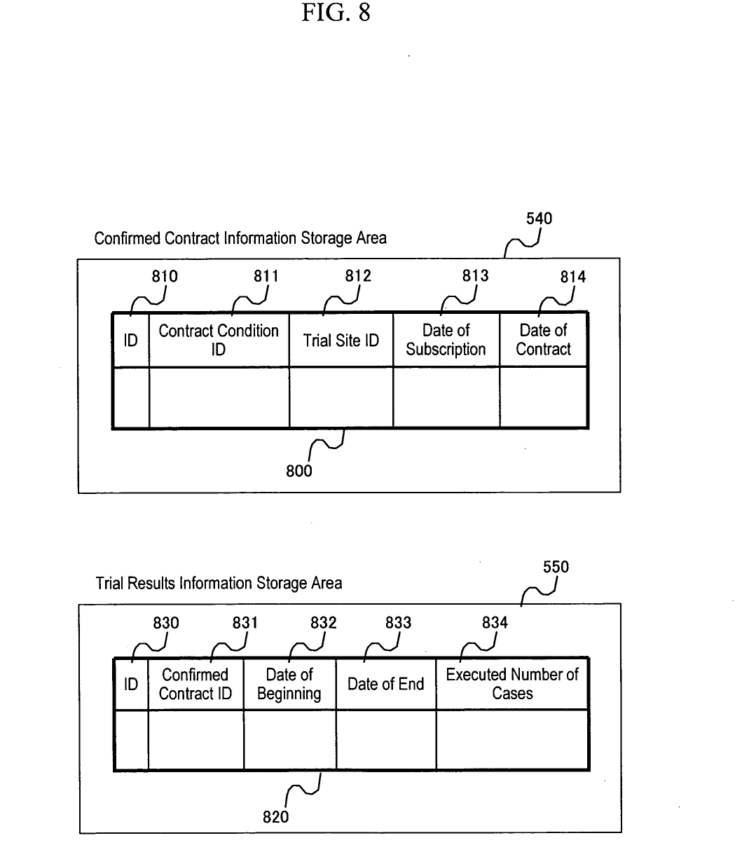

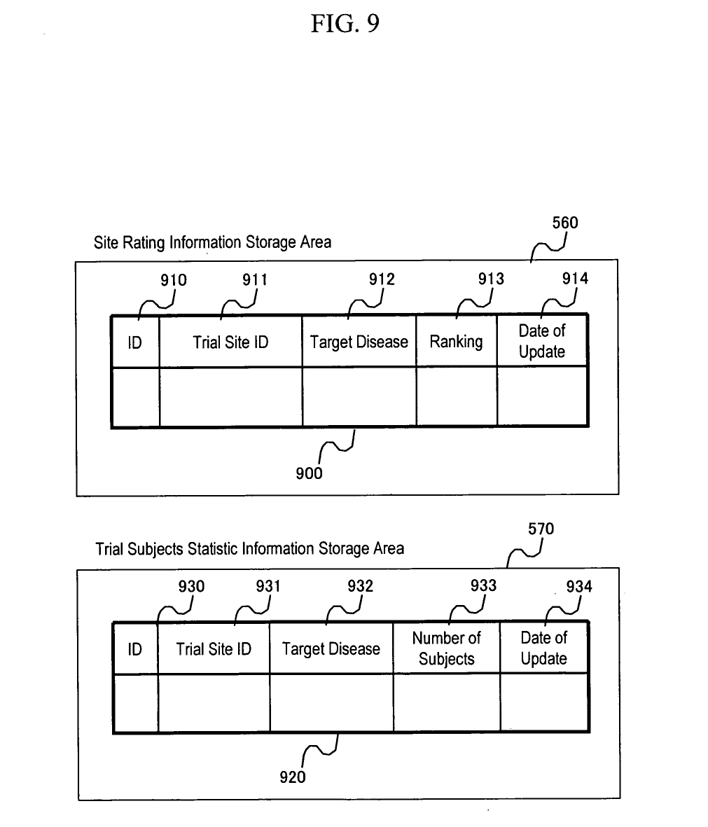

FIG. 5 is a block diagram showing the area for tables stored in the clinical trial contract support database. The reference numeral 500 is a sponsor information storage area for storing information on the sponsors A and B, reference numeral 510 is a trial site information storage area for storing information on the trial sites a, b, and c; reference numeral 520 is a trial basic information storage area for storing information relating to the clinical trial, reference numeral 530 is a contract condition information storage area for storing contract conditions for the clinical trial, reference numeral 540 is a confirmed contract information storage area for storing information relating to the confirmed contract, reference numeral 550 is a trial results information storage area for storing result information on completed clinical trials, reference numeral 560 is a site rating information storage area for storing information ranking the trial sites, a b, c, reference numeral 570 is a trial subjects statistic information storage area for storing volunteer database information on the trial sites, a b, c. The sponsor information storage area 500 and the trial site information storage area 510 are described using FIG. 6. The trial information storage area 520 and the contract condition information storage area 530 are described using FIG. 7. The confirmed contract information storage area 540 and the trial results information storage area 550 are described using FIG. 8. The site rating information storage area 560 and the trial subjects statistic information storage area 570 are described using FIG. 9.

The clinical trial contract support system 440 in this way manages each type of information acquired from the sponsors A and B and the trial sites a, b, and c, and distributes the information as needed using the process and information service unit 410. The process and information service unit 410 processes different types of clinical trial information input from the sponsor A, B terminal 200 and the trial site a, b, and c terminal 300, and the information is then stored in the clinical trial contract support database 420 so that contracts can be easily formed between the sponsors A and B and the trial sites a, b, c.

FIG. 6 is a drawing showing the table storing the sponsor information storage area and the trial site information storage area.

Reference numeral 600 is the sponsor information table stored in the sponsor information storage area 500. Numeral 610 is the ID area for managing the primary keys of the sponsor information table 600, reference numeral 611 is the user name area for managing the user names of the sponsors, numeral 612 is the password area for managing the passwords of the sponsors, reference numeral 613 is the trade name area for managing the trade names of the sponsors, reference numeral 614 is the address area for managing the addresses of the sponsors, reference numeral 615 is the telephone number area for managing the telephone numbers of the sponsors, reference numeral 616 is the capital fund area for managing the capital funds of the clinical trial sponsors, reference numeral 617 is the number of employees area for managing the number of employees of the sponsors. The reference numeral 620 is a trial site information table stored in the trial site information storage area 510. the reference numeral 630 is the ID area for managing the primary keys for the trial site information table 620, reference numeral 631 is the user name area for managing the user names of the trial sites, reference numeral 632 is the password area of managing the passwords of the trial sites, reference numeral 633 is the site name area for managing the site names of the trial sites, reference numeral 634 is address area for the managing the addresses of the trial sites, reference numeral 635 is a telephone number area managing the telephone numbers of the trial sites, 636 is a number of sickbeds area for managing the number of sickbeds of the trial sites, reference numeral 637 is the number of outpatients area for managing the number of outpatients of the trial sites, and reference numeral 638 is the number of departments area for managing number of departments at the trial site.

The interface for registering information onto the sponsor information table 600 is described in detail using FIG. 11. The interface for registering information onto the trial site information table 620 is described in detail using FIG. 12.

The clinical trial contract support system 440 in this way manages the user information acquired from the sponsors A and B and the trial sites a, b, and c, and distributes the information as needed using the process and information service unit 410. Support for easily forming contracts between the sponsors A and B and the trial sites a, b, c is rendered by managing the different types of clinical trial information in the sponsor information table 600 and the trial site information table 620 input from the sponsor A, B terminal 200 and the trial sites a, b, and c terminal 300.

FIG. 7 is a drawing showing the table stored in the trial basic information storage area and the contract condition storage area. The reference numeral 700 is the trial basic information table stored in the trial basic information storage area 520, reference numeral 710 is the ID area for managing the primary keys of the trial basic information table 700, reference numeral 711 is the sponsor ID area for managing the foreign keys to the sponsor information table 600, reference numeral 712 is the trial name area for managing the names of the trials the sponsors A and B requested to the trial sites a, b, and c, reference numeral 713 is the target disease area for managing the names of the target diseases in the requested clinical trial, reference numeral 714 is a phase area for managing the phases of the clinical trial, reference numeral 715 is the inclusion/exclusion criteria area for managing internal criteria and external criteria for the requested trial, reference numeral 716 is a protocol area for managing the protocol of the requested trial, reference numeral 717 a total length of trial area for managing the trial period, reference numeral 718 is a total number of cases area for managing the total number of cases of the requested trial, and reference numeral 719 is a total cost area for managing the total cost of the requested trial. The reference numeral 720 is a contract condition information table stored in the contract condition information storage area, the reference numeral 730 is a ID area for managing the primary keys of the contract condition information table 720, reference numeral 731 is a trial basic ID for managing the foreign key to the trial basic information table 700, reference numeral 732 is a length of trial area for managing the period to implement the trial, reference numeral 733 is a number of trial sites area for managing the number of trial sites to be implemented, reference numeral 734 is the number of cases area for managing the number of cases accepted, the reference numeral 735 is a unit cost area for managing the unit cost of the accepted cases.

Here, the term “phase” indicates the steps of the clinical trial. Phases from I through IV are present and are executed in sequence. Phase I is a clinical trial of a small number of healthy individuals; phase II is a clinical trial for a small number of unhealthy individuals, phase III is a clinical trial for a large number of unhealthy individuals, and phase IV is a clinical trial for a large number of individuals after the medicine was sold (http://www.vob.jp/chikenl.html). The term “protocol” here indicates items established by the sponsor such as how the drug is taken, and how many days pass between examinations, etc.

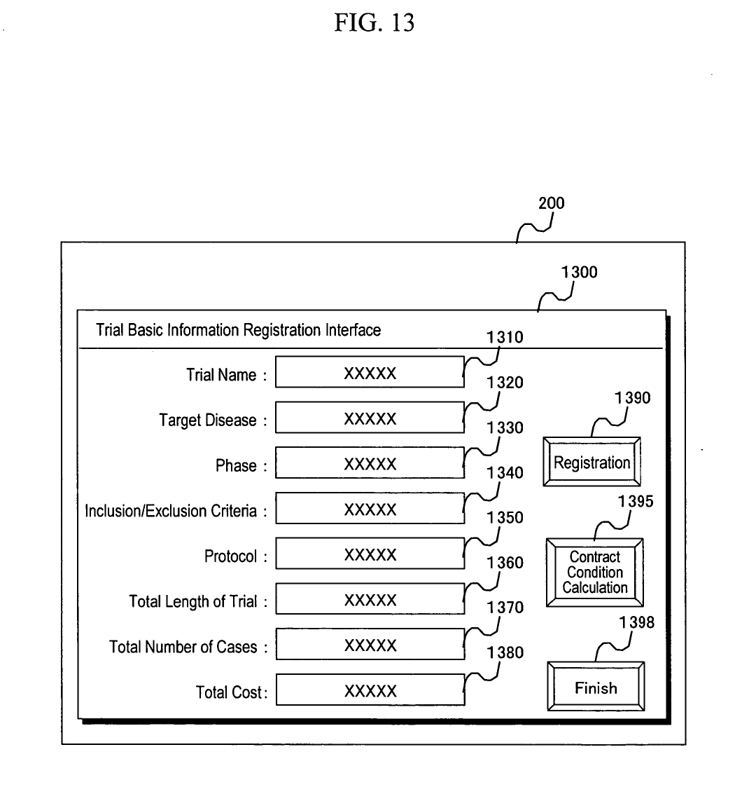

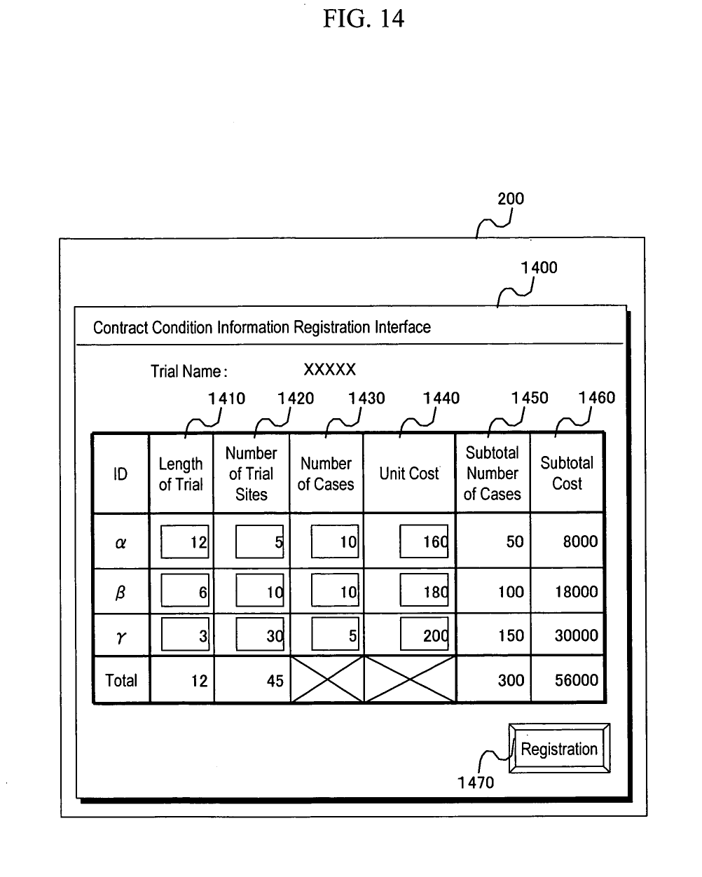

The interface for registering information into the trial basic information table 700 is described in detail using FIG. 13. The interface for registering information into the contract condition information storage table 720 is described in detail using FIG. 14.

The clinical trial contract support system 440 in this way manages the contract condition information for the trial and information on the trial that the sponsors A and B want performed. By utilizing the process and information service unit 410 to distribute information, the trial sites a, b, and c can acquire information on the clinical trials that their institution wants to perform. By registering in advance, the contract conditions and the trial basic information in this way, the trial site can select the desired clinical trial and contract conditions from among the applicable information.

FIG. 8 is a drawing for describing the table stored in the confirmed contract information storage area and the trial results information storage area. The reference numeral 800 is the confirmed contract information table stored in the confirmed contract information storage area 540, the numeral 810 is an ID area for managing the primary key for the confirmed contract information table 800, the numeral 811 is a contract condition ID area for managing the foreign key for the contract condition information table 720, the reference numeral 812 is a trial site ID area for managing the foreign key for the trial site information table 620, the numeral 813 is the date of subscription area for storing the date (year, month, day) of application for reply to the contract conditions stored in the contract condition ID 811, the numeral 814 is the date of contract area for managing the date that the contract for the clinical trial was confirmed. The reference numeral 820 is the trial result information table stored in the trial results information storage area 550, the reference numeral 830 is ID area for managing the primary key for the trial result information table 820, the reference numeral 831 is a confirmed contract ID area for managing the foreign key for the confirmed contract information table 800, the reference numerals 832 and 833 are respectively the date of beginning (or start date) and date of end (or end date) for managing the start date and end date for the clinical trial that was performed, and the reference numeral 834 is the executed number of cases area for managing the number of cases that were actually processed in the clinical trial that was performed.

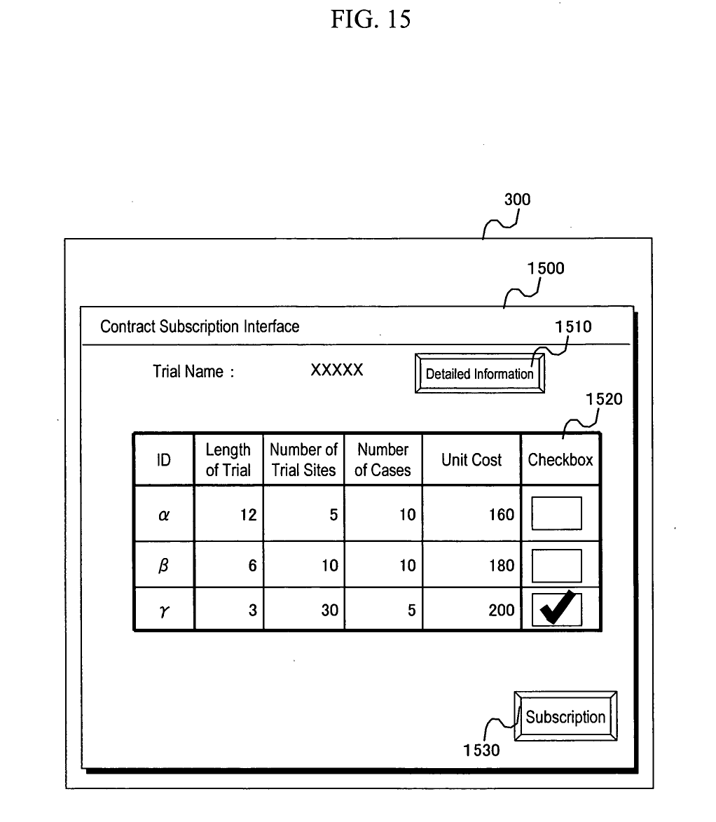

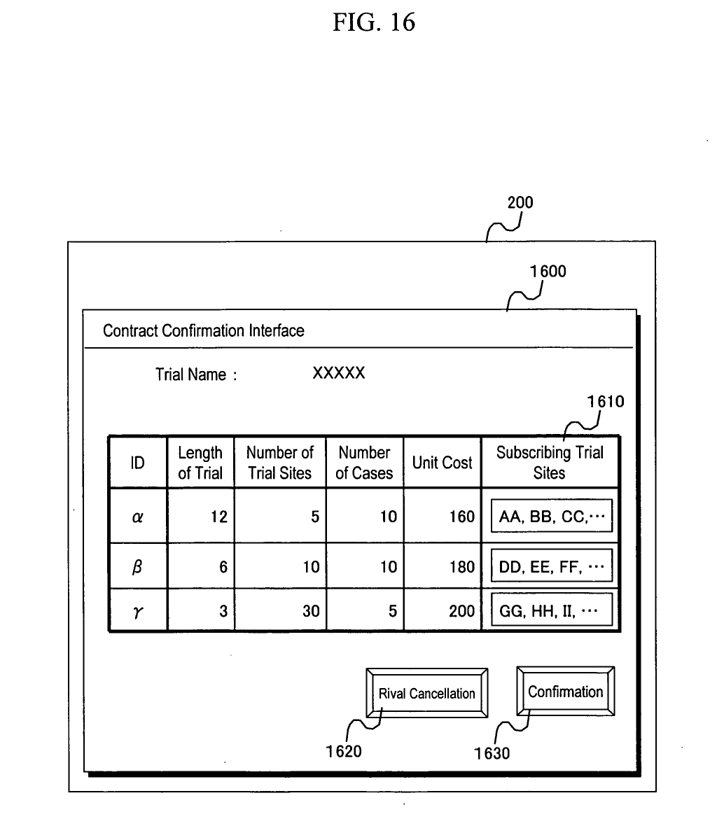

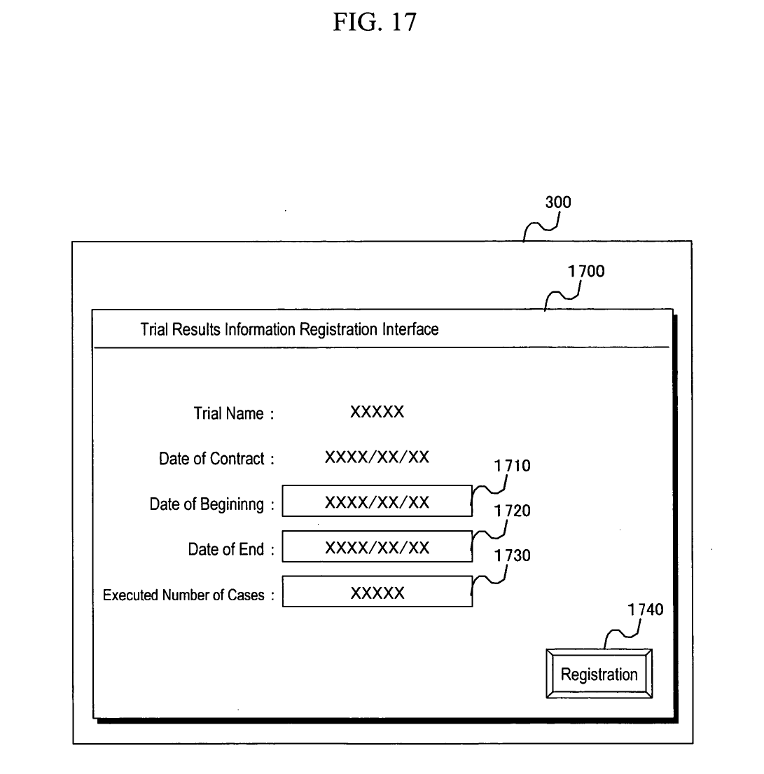

The interface for registering information onto the confirmed contract information table 800 is described in detail using FIG. 15 and FIG. 16. The interface for registering information onto the trial results information table 820 is described in detail using FIG. 17.

The clinical trial contract support system 440 monitors information on the trial sites a, b, c that responded to each of the contract conditions and the date of that response, or monitors the contract date when a contract was established with the applicable clinical trial site. Moreover, by monitoring the result information of the clinical trials performed for each established contract, the information can be fed back to the rating information shown in FIG. 9. By in this way managing information relating to the contract and result information for the trials that were implemented, information from competing trial sites can be used as rating (evaluation) information when entering into a new contract.

FIG. 9 is a drawing showing the table stored in the site rating information storage area and the trial subjects statistic information storage area. The reference numeral 900 is the site rating information table stored in the site rating information storage area 560, reference numeral 910 is the ID area for managing the primary key of the site rating information table 900, reference numeral 911 is the trial site ID for managing the foreign key to the trial site information table 620, reference numeral 912 is the target disease area for managing the target disease names, the reference numeral 913 is the ranking area for managing the ranking of the trial site, numeral 914 is the date of update area for managing the date that the information was updated (rewritten), and the reference numeral 920 is the trial subjects statistic information table stored in the trial subjects statistic information storage area 570. The reference numeral 930 is the ID area for managing the primary key of the trial subjects statistic information table 920, reference numeral 931 is the trial site ID for managing the foreign key to the trial site information table 620, the reference numeral 932 is the target disease area for the managing the target disease names, the reference numeral 933 is the number of subjects area for managing the number of trial subjects managed in the target disease area 932, and the reference numeral 934 is the date of update area for managing the dates that the information was updated (rewritten).

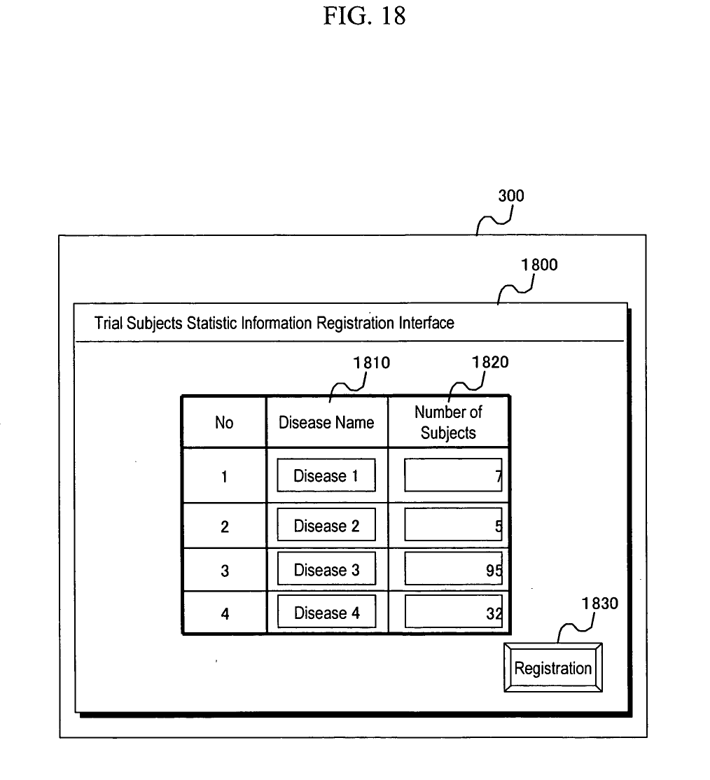

The interface for registering information onto the site rating information table 900 is described in detail using FIG. 17. The interface for registering information onto the trial subjects statistic information table 920 is described in detail using FIG. 18.

The clinical trial contract support system 440 manages the information rating (or ranking) for each trial site, and can utilize this information as rating information when (sites are) competing for a contract. By managing the target disease and the number of trial subjects per target disease in the same way, the latest information on the trial sites can be provided to the sponsors. By managing the ranking information on each trial site, that information can be utilized as rating information when trial sites are competing for a new contract. Also, monitoring the statistical information in the database allows the trial site to enhance the appeal of its own institution ability to accept and handle trials. Moreover the sponsor can acquire basic data for selecting the best site for the trial from among multiple trial sites.

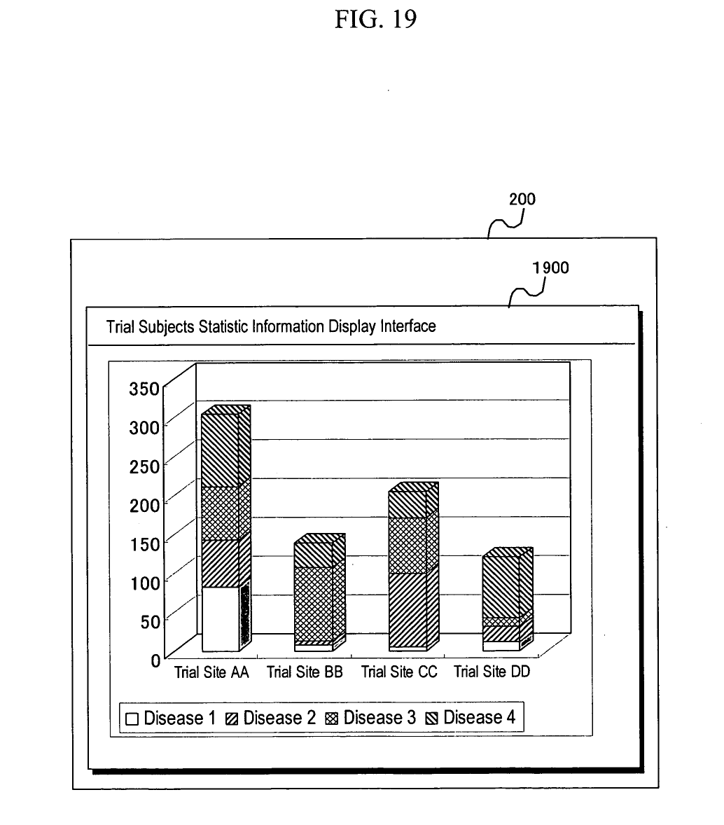

FIG. 10 is a block diagram showing the structure of the process and information service unit 410. The reference numeral 1000 is an information service unit for distributing each interface shown in FIG. 11 from FIG. 19 to the terminal 200 for sponsors A, B, and the terminal 300 for the trial sites a, b, c. The reference numeral 1010 is a contract condition calculation unit for generating each type of contract condition shown in detail in FIG. 14. The reference numeral 1020 is an subscription rival calculation unit for eliminating competition when there is a deluge of responses from multiple trial sites for the contract condition shown in detail in FIG. 16. Reference numeral 1030 is a site rating information update unit for updating (rewriting) the rating information utilized for rating when eliminating competition with the subscription rival calculation unit 1020. The site rating information update unit 1030 is described in detail in FIG. 17.

The clinical trial contract support system 440 handles the input information and each interface distributed by the information service unit 1000 in FIG. 11 from FIG. 19. The contract condition calculation unit 1010 starts up when setting contract conditions for the trial, and automatically generates suitable contract conditions that can be selected by the trial sites a, b, c, based on the period (trial length), (total) number of cases and (total) budget registered by sponsors A and B. The subscription rival calculation unit 1020 starts up when there is a deluge of multiple competing trial sites responding to the contract condition, and refers to the rating information table 900 to automatically select a suitable trial site. The site rating information update unit 1030 starts up when the information in the trial result information table 820 is updated (rewritten), and updates (rewrites) the information in the site rating information table 900.

Utilizing the above structure allows the information service unit 1000 to provide appropriate information to the sponsors A, B and the trial sites a, b, and c, and collect information needed for the contract. The contract condition calculation unit 1010 automatically generates suitable contract conditions that can be selected by the trial sites a, b, c, based on the period, number of cases, and budget information relating to the clinical trial registered by the sponsors A, B, and can therefore eliminate the troublesome task of setting contract conditions that should be set by the sponsors. The subscription rival calculation unit 1020 refers to the site rating information to automatically eliminate conflicts when there is a deluge of responses from multiple trial sites for the proposed contract conditions generated by the contract calculation unit 1010 and relating to ratings updated by the site rating information update unit 1030. This calculation unit 1020 therefore reduces the task of eliminating competing sites that the sponsor should itself perform. The task of eliminating competing sites utilizes the rating information based on result information from trials performed in the past so that the ratings are performed based on facts. The site rating information update unit 1030 collects result information from the trial sites relating to trials implemented from established contracts, and updates the rating information based on the result information. In this way, rather than just performing a trial that was commissioned, the sponsor and the trial site can obtain rating information when entering into a new contract, by means of feedback conveyed as result information.

FIG. 11 is a drawing showing the interface for allowing the sponsor to register the sponsor information. The reference numeral 1100 is the sponsor information registration interface for registering information into the sponsor information table 600, reference numeral 1110 is a user name entry area for entering the user name into the user name area 611. Reference numeral 1120 is a.password entry area for entering the password into the password area 612. Reference numeral 1130 is a trade name entry area for entering the trade name into the trade name area 613. Reference numeral 1140 is an address entry area for entering addresses into the address area 614. Reference numeral 1150 is a telephone number entry area for entering telephone numbers onto the telephone number area 615. Reference numeral 1160 is a capital fund entry area for entering the capital fund into the capital fund entry area 616. Reference numeral 1170 is a number of employees area for entering the number of employees into the number of employees area 617. Reference numeral 1180 is registration button for registering the above information into the clinical trial contract support database 420.

The sponsors A, B enter their own user information utilizing the interfaces, and the information service unit 1000 registers the applicable information in the sponsor information table 600 when the registration button 1180 is pressed. The sponsors A, B utilize the sponsor information registration interface 1100 for user registration in the clinical trial contract support system so that contracts can be smoothly formed with the trial sites a, b, c.

FIG. 12 is a drawing showing the interface for allowing the trial site to register site information. The reference numeral 1200 is a trial site information registration interface for registering information into the trial site information table 620; reference numeral 1210 is a user name entry area for entering the user name into the user name area 631; reference numeral 1220 is a password entry area for entering the password into the password area 632; reference numeral 1230 is a site name entry area for entering the site name into the site name area 633; reference numeral 1240 is an address entry area for entering addresses into the address area 634; reference numeral 1250 is a telephone number entry area for entering telephone numbers into a telephone number area 635; reference numeral 1260 is a number of sickbeds entry area for entering the number of sickbeds into the number of sickbeds area 636; reference numeral 1270 is a number of outpatients entry area for entering the number of outpatients into the number of outpatients area 637; reference numeral 1280 is a number of departments entry area for entering the number of departments into the number of departments area 638; reference numeral 1290 is a registration button for registering the above information into the clinical trial contract support database 420.

The trial sites a, b, c use the above interface to enter their own user information. Pressing the button 1290 makes the information service unit 1000 to enter that information in the trial site information table 620. The trial sites a, b, c, register the user in the clinical trial contract support system by using the trial site information registration interface 1200 so that contracts can be smoothly formed with the trial sites a, b, c.

FIG. 13 is a drawing of the interface allowing the sponsor to register the trial basic information. The reference numeral 1300 is a trial basic information registration interface for registering information in the trial basic information table 700. The reference numeral 1310 is a trial name entry area for entering the trial name in the trial name area 712; reference numeral 1320 is a target disease entry area for entering the disease name in the target disease area 713; reference numeral 1330 is a phase entry area for entering phase information in the phase area 714; reference numeral 1340 is inclusion/exclusion criteria entry area for entering inclusion/exclusion criteria into the inclusion/exclusion criteria area 715; reference numeral 1350 is a protocol entry area for entering a protocol into the protocol area 716; reference numeral 1360 is a total length of trial entry area for entering the trial period into the length of trial area 717; reference numeral 1370 is a total number of cases entry area for entering the total number of cases in the total number of cases area 718; reference numeral 1380 is a total cost entry area for entering the total cost into the total cost area 719; reference numeral 1390 is a registration button for registering the above information into the clinical trial contract support database 420; reference numeral 1395 is a contract condition calculation button for displaying the contract condition information registration interface shown in detail in FIG. 14; and the reference numeral 1398 is a finish button for terminating the processing. Depressing the contract condition calculation button 1395 displays the contract condition information registration interface described using s FIG. 14.

The operator enters information for executing the trial requested by the sponsors A, B by utilizing the interface, and presses the registration button 1390 so that the information service unit 1000 registers the applicable information in the trial basic information table 700. The sponsors A, B utilize the trial basic information registration interface 1300 to register trial information requested of the trial sites a, b, c, in advance so that the trial sites a, b, c, can themselves select a desired clinical trial.

FIG. 14 is a drawing of the interface allowing the sponsor to register contract condition information. The reference numeral 1400 is a contract condition registration interface for registering information in the contract condition information table 720; reference numeral 1410 is a length of trial entry area for entering the trial period in the length of trial area 732; reference numeral 1420 is a number of trial sites entry area for entering the number of trial sites into the number of trial sites area 733; reference numeral 1430 is a number of cases entry area for entering the number of cases into the number of cases area 734; reference numeral 1440 is a unit cost entry area for entering the unit cost into the unit cost area 735; reference numeral 1450 is a subtotal number of cases display area for displaying a subtotal of the number of cases as the product of the number of cases displayed in the number of cases entry area 1430 and the number of trial sites displayed in the number of trial sites entry area 1420; reference numeral 1460 is the (trial) subtotal cost display area for displaying the subtotal of trial costs as the product of the unit cost displayed in the unit cost entry area 1440 and the subtotal of the number of cases displayed in the number of cases display area 1450; and the reference numeral 1470 is a registration button for registering the above information in the clinical trial contract support database 420.

The information service unit 1000 starts the contract condition calculation unit 1010 when the sponsors A, B press the contract condition calculation button 1395. The contract condition calculation unit 1010 generates multiple contract conditions based on the trial period entered in the total length of trial entry area 1360, the total number of cases entered in the total number of cases entry area 1370, and the total cost entered in the total cost entry area 1380.

The contract conditions for example for the trial period (length of trial) are generated by multiplying the trial period entered in the total length of trial area by 1, 0.5 or 0.25 times. The number of cases is generated in the same way, by multiplying the total number of cases entered in the total number of cases entry area 1370 by 1, 0.5 or 0.25 times. The market determines the value of the (case) unit cost to some extent so case unit cost proposal conditions may be generated by multiplying the applicable figure by 1, 1.2, or 1.4 times. The number of trial sites may be calculated by solving the simultaneous equation for that value. The method for calculating the contract conditions is not limited to the above examples.

The information service unit 1000 loads the contract conditions generated as described above, and displays them on the contract condition registration interface 1400. The sponsor A, B depresses the registration button 1470 if the displayed contract conditions are suitable. If these contract conditions are not suitable, then the sponsors A, B change the figures displayed in the number of trial sites entry area 1420, number of cases entry area 1430, and unit cost entry area 1440 to correct them to suitable values. In this case, the information service unit 1000 recalculates the figures so that no conflicts occur in the figures displayed in the subtotal number of cases display area 1450 and the subtotal cost display area 1460.

The information service unit 1000 registers the contract condition information displayed on the contract condition registration interface 1400 into the contract condition information table 720 when the sponsors A, B depress the registration button 1470. The contract condition calculation unit 1010 can in this way generate suitable contract conditions selectable by the trial sites a, b, c, based on the period (length of trial), total case count and total cost information on the trial registered by the sponsors A, B, so that the troublesome task of the sponsors themselves setting the contract conditions can be eliminated.

FIG. 15 is a drawing of the interface for the trial site to subscribe to the contract condition. The reference numeral 1500 is a contract subscription interface for registering a response (application) in the confirmed contract information table 800; reference numeral 1510 is a detailed information button for display detailed information on the applicable trial; reference numeral 1520 is a contract condition checkbox area for responding (applying for) to the desired contract conditions; and the reference numeral 1530 is a subscription button for registering the above information in the clinical trial contract support database 420.

The trial sites a, b, c subscribe to the desired contract conditions by entering a checkmark in the contract condition checkbox area 1520 by utilizing the interface. When the trial sites a, b, c depress the subscription button 1530, the information service unit 1000 registers that trial site and the date of its subscription in the confirmed contract information table 800. When the trial sites a, b, c depress the detailed information button 1510, the information service unit 1000 displays detailed information relating to the applicable trial. An interface resembling the trial basic information registration interface 1300 shown in FIG. 13 may be utilized as the display interface for the detailed information. Utilizing this type of interface allows the trial site to select the desired trial and contract conditions from among the pre-registered contract conditions and trial information.

FIG. 16 is a drawing of the interface for allowing the sponsor to confirm the contract. The reference numeral 1600 is the contract confirmation interface for registering the contract confirmation information in the confirmed contract information table 800; reference numeral 1610 is the subscribing trial sites entry area for displaying the trial sites subscribing to the applicable contract condition positions; reference numeral 1620 is a rival cancellation button for eliminating rival candidates when more than the number of trial sites has subscribed to the contract conditions; reference numeral 1630 is a confirmation button for registering the confirmed contract in the clinical trial contract support database 420.

The sponsors A, B confirm the trial site that subscribed to the contract conditions. Here, when there are competing subscription, the information service unit 1000 starts the subscription rival calculation unit 1020 when the sponsors A, B depress the rival cancellation button 1620. The subscription rival calculation unit 1020 acquires the rating information relating to the trial site displayed in the subscribing trial sites 1610 from the site rating information table 900, selects just the number of sites from the upper rank, and redisplays it on the subscribing trial sites entry area 1610.

The sponsors A, B confirm if the clinical trial site redisplayed in the subscribing trial sites entry area 1610 is suitable or not and if suitable depress the confirmation button 1630. The information service unit 1000 registers the current date in the date of contract area 814 of the confirmed contract information table 800 according to information on the trial sites displayed in the subscribing trial sites entry area 1610, and establishes the trial contract. A rival cancellation unit for eliminating competing applications is available using the interface so that when there is a deluge of responding applications from multiple trial sites for certain contract conditions, the unit refers to the rating information and automatically cancels rivals so that the task of eliminating rivals usually performed by the sponsor itself is eliminated.

FIG. 17 is a drawing describing the interface for allowing the trial sites to register results information of trials. The numeral 1700 is a trial results information registration interface for registering information in the trial results information table 820; the reference numeral 1710 is a date of beginning entry area for entering the date the trial started, into the date of beginning area 832; reference numeral 1720 is the date of end entry area for entering the date the trial ended, into the date of end area 833, reference numeral 1730 is an executed number of cases entry area for entering the number of cases actually performed, into the executed number of cases area 834; and the reference numeral 1740 is a registration button for registering the above information into the clinical trial contract support database 420.

The operator utilizes the above interface to enter the trial start date, end date, and number of cases actually performed, as information relating to trials performed by the trial sites a, b, c, and when the registration button 1740 is depressed, the information service unit 1000 registers that information into the trial results information table 820. The site rating information update unit 1030 starts up when updating information by registration into the trial results information table 820. The site rating information update unit 1030 compares the information in the contract condition information table 720 with the information in the trial results information table 820, corrects the ranks from remaining trial sites with results satisfying the contract conditions, and rewrites the information in the site rating information table 900. By collecting result information from trial sites on trials that were performed, the sponsor can obtain information for evaluating a new contract with a trial site.

FIG. 18 is a drawing describing the interface for allowing the trial sites to register trial subjects statistic information. Reference numeral 1800 is a trial subjects statistic information registration interface for registering information into the trial subjects statistic information table 920; reference numeral 1810 is the disease name entry area for entering the target disease name into the target disease name area 932; reference numeral 1820 is the number of subjects entry area for entering the number of trial subjects in the number of subjects area 933; reference numeral 1830 is the registration button for registering the above information into the clinical trial contract support database 420.

The operator uses the above interface to enter information on the disease name and number of trial subjects that the trial sites a, b, c, acquired from the volunteer database 310, and when the registration button 1830 is pressed, the information service unit 1000 registers that information in the trial subjects statistic information table 920. By registering trial subjects statistic information via the above interface, the trial site can enhance the appeal of its own institution through its ability to accept and perform trials.

FIG. 19 is a drawing describing the interface for allowing the sponsor to display the trial subjects statistic information. The reference numeral 1900 is a trial subjects statistic information display interface for acquiring information from the trial subjects statistic information table 920, visualizing it, and displaying it.

The information service unit 1000 refers to the trial subjects statistic information table 920 when the sponsors A, B start up the above interface, and generates a display using the latest information. By using the above interface to display the trial subjects statistic information, the sponsor can acquire basic data for selecting the best site for the trial from among multiple trial sites.

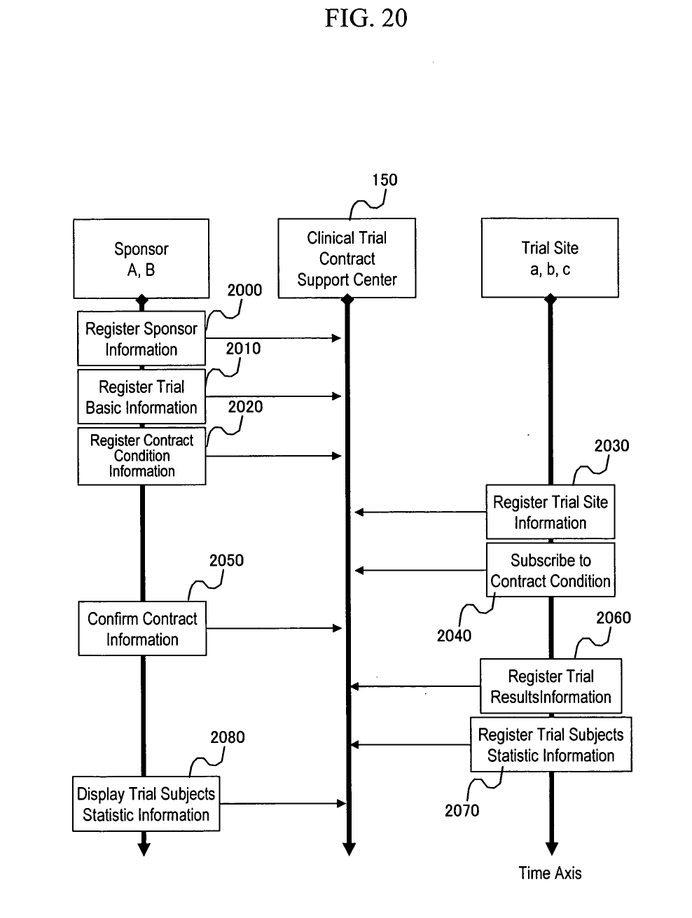

FIG. 20 is a drawing of operation of the clinical trial contract support center shown along a time axis. The sponsors A, B first of all register the sponsor information in the clinical trial contract support center 150 and acquire access rights to the clinical trial contract support system of this invention (step 2000). The sponsors next register in the clinical trial contract support center 150 the trial basic information they wish to request (step 2010), and also register the contract condition information generated based on the trial basic information (step 2020), and then terminate registration of the trial information.

The trial sites a, b, c, on the other hand, register their own trial site information in the clinical trial contract support center 150 and acquire access rights to the clinical trial contract support system of this invention (step 2030). The sites a, b, c next view the registered trial information and subscribe to a contract condition for a desired trial (step 2040). At this point only registration has been performed and there is no contract.

The sponsors A, B confirm the contract (step 2050) at the approximate point in time that contract registration was performed, and a contract between the sponsors A, B and the trial sites a, b, c is established according to the confirmed information.

The trial sites a, b, c that received the order for a trial, promptly start the trial, and register the result information (step 2060) when the trial is complete. The clinical trial contract support center 150 updates the rating information based on the result information, and prepares for competing applications for a new contract.

On the other hand, in order to enhance the appeal of their own institution in terms of its ability to perform trials, the trial sites a, b, c enter trial subjects statistic information in the clinical trial contract support center 150 (step 2070). The step 2070 need not be implemented after the step 2060, and the trial site information in step 2030 can be executed any time if registration was completed.

In order to find the best trial site to request performing a trial, the sponsors A, B, access the clinical trial contract support center 150, display the trial subjects statistic information (step 2080), and acquire the latest information on the trial sites. The step 2080 need not be implemented after the step 2050, and the sponsor information in step 2000 can be executed any time if registration was completed.

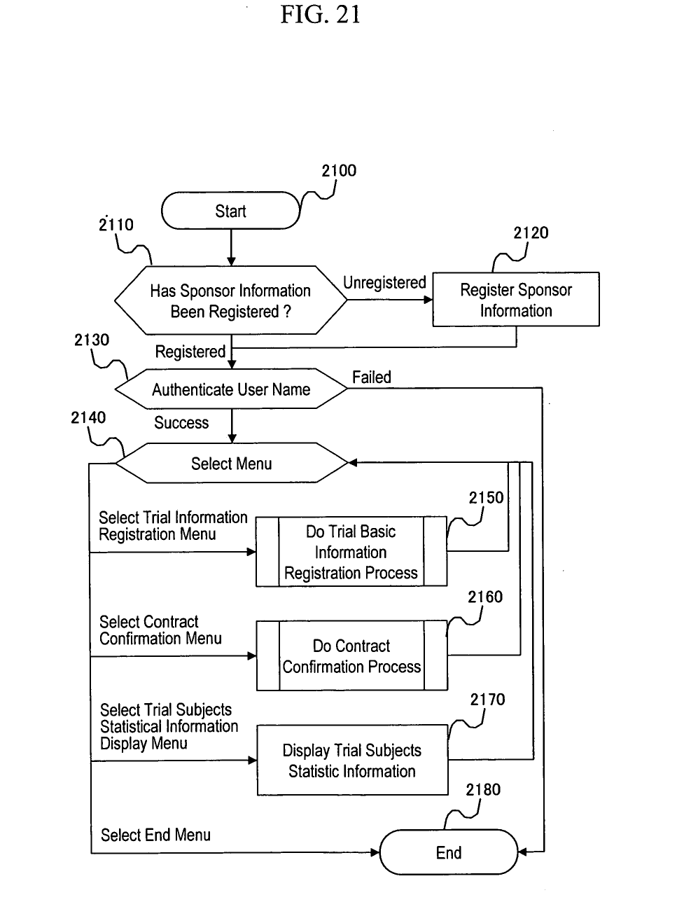

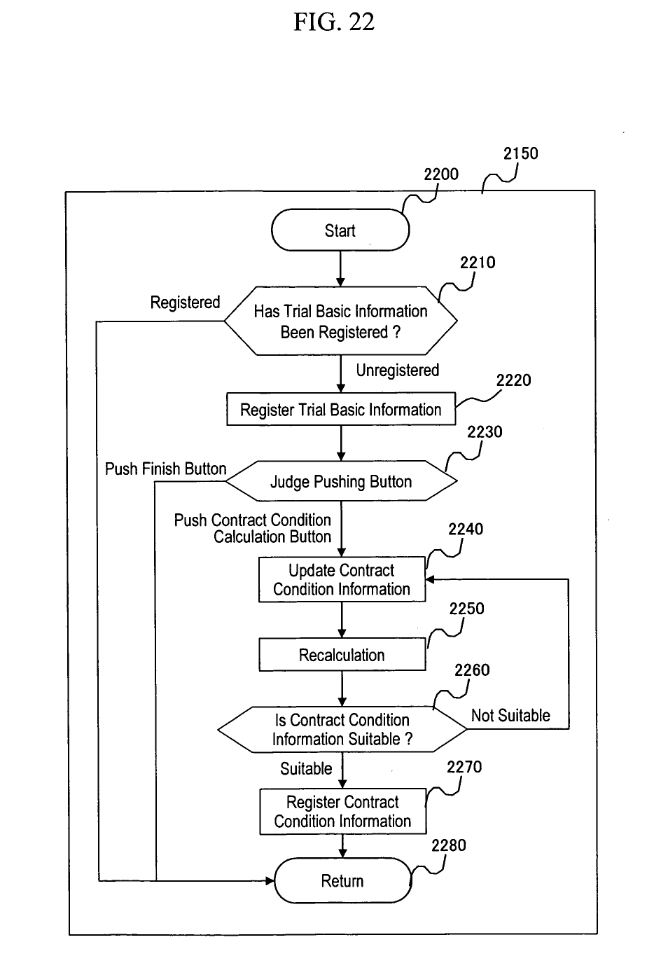

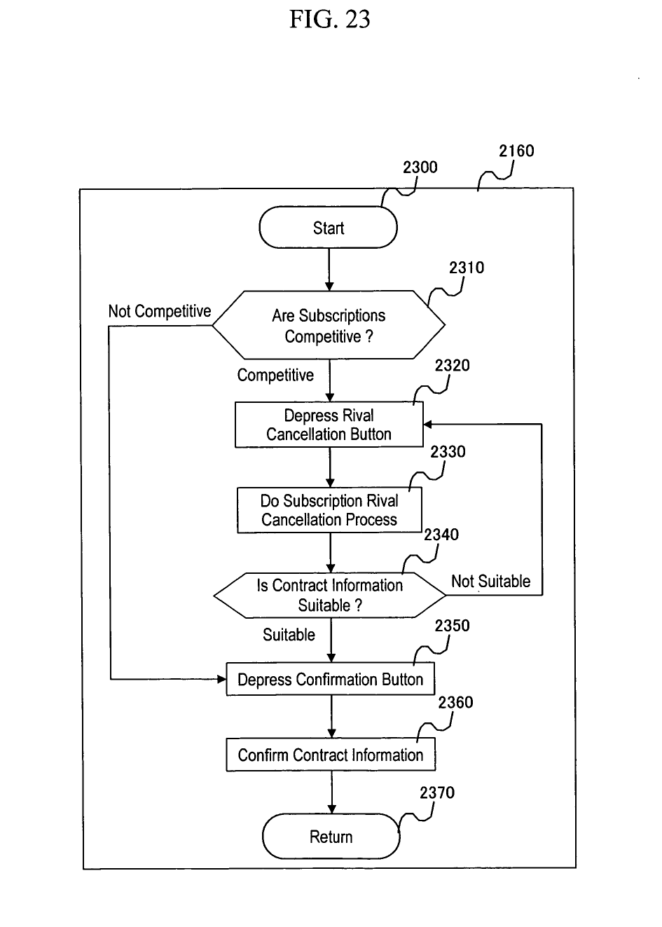

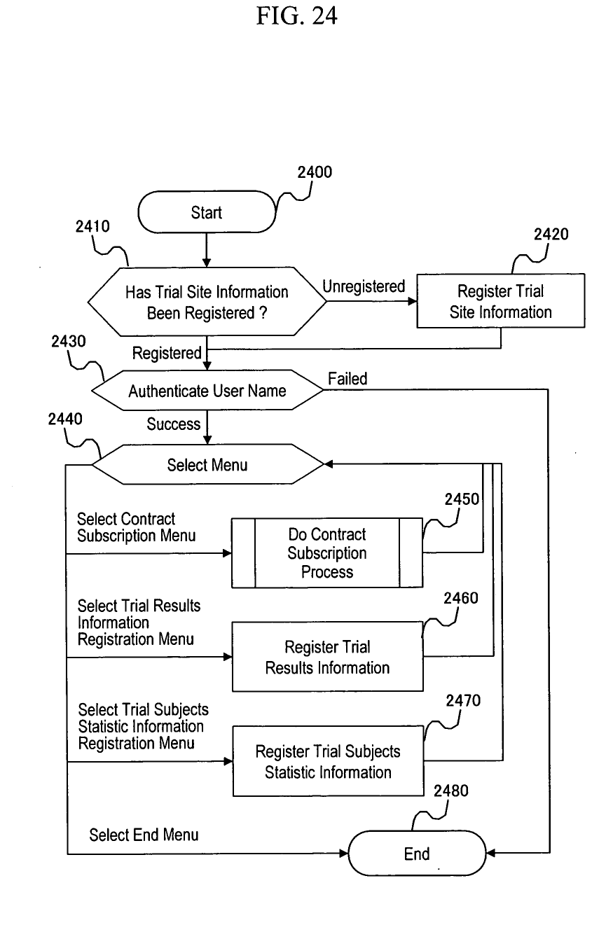

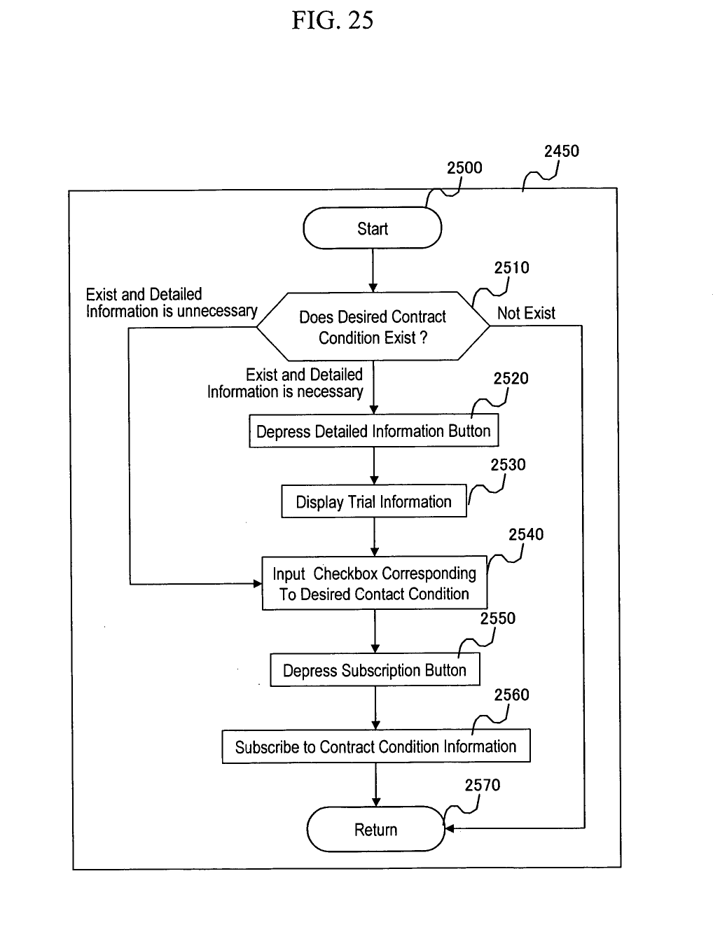

The processing procedures used by the sponsors A, B are described using FIG. 21, FIG. 22, and FIG. 23. The processing procedures used by the trial sites a, b, c, are described using FIG. 24 and FIG. 25.

The above processing allows the sponsor to disclose trial information and contract conditions for the trial the sponsor wants to request, and allows the trial site to view the disclosed information and freely select a desired trial for their own institution. Moreover, the sponsor can collect result information from the trial sites relating to trials already performed, and by then updating the rating information based on that result information, the sponsor can obtain information for making evaluations when forming a new contract with the trial site. Also, by managing the trial subjects statistic information, the trial sites can enhance their appeal to the sponsor by showing the ability of their institution to perform trials. The sponsor can also acquire basic data for selecting the best site from among multiple trial sites.

FIG. 21 is a flow chart showing the overall procedures performed by the sponsor in the clinical trial contract support system.

When the sponsors A, B access the clinical trial contract support system using the terminal 200 (step 2100), the information service unit 1000 refers to the sponsor information table 600 and decides if registration of sponsor information is complete or not (step 2110). When registration of sponsor information is not complete, the sponsor information registration interface 1100 shown in FIG. 11 appears, and urges the sponsor A, B to enter the sponsor information. When the sponsor A, B depresses the registration button 1180, the information service unit 1000 terminates the process (step 2120) after the sponsor information was entered I the sponsor information table 600, and authenticates the user (step 2130). If registration of the sponsor information was finished in step 2110, the user authentication is performed (step 2130). If the user authentication failed in step 2130, then the process terminates (step 2180).

When the user authentication in step 2130 succeeds, then the menu can be selected. In step 2140, the trial information registration process is executed (step 2150) when the trial information registration menu was selected, and the process returns to step 2140. When the contract confirmation menu was selected in step 2140, the contract confirmation processing is executed (step 2160) and the process returns to step 2140. When the trial subjects statistic information display menu is selected in step 2140, the trial subjects statistic information display interface shown in FIG. 19 appears (step 2170) and the process returns to step 2140. When the end menu was selected in step 2140, then the process terminates (step 2180).

The trial information registration process is described utilizing FIG. 22. The contract confirmation process is described utilizing FIG. 23.

By registering site information and contract conditions in advance using the above process of this invention, the trial site can select desired trial and contract conditions from the applicable information.

By managing the trial subjects statistic information in this way, the sponsor can acquire basic data for selecting the best trial site for the trial from among multiple trial sites.

FIG. 22 is a flow chart showing the procedures in the trial information registration process.

When the trial information registration process 2150 is executed (step 2200), the clinical trial contract support system refers to the trial basic information table 700, and decides if registration of the trial basic information was completed (step 2280). In step 2210, if registration of the trial basic information is not complete, then the trial information registration interface 1300 appears and urges the sponsors A, B to enter the trial basic information. When the sponsors A, B depress the registration button 1390, the information service unit 1000 registers the trial basic information in the trial basic information table 700 (step 2220).

The information service unit decides the button was depressed (step 2230), and the process terminates if the finish button 1398 is pressed (step 2280). In step 2230, when the contract condition calculation button 1395 was depressed, the conditions calculated by the contract condition calculation unit 1010 are loaded, and displayed on the contract condition information registration interface 1400 shown in FIG. 14, urging the sponsors A, B to enter the contract condition information. When the sponsors A, B have changed (step 2240) the contract condition information displayed on the contract condition information registration interface 1400, the information service unit 1000 recalculates and displays the subtotal number of cases display area 1450 and subtotal cost display area 1460 based on the applicable changed values (step 2250).

The sponsors A, B decide if the contract condition information displayed on the contract condition information registration interface 1400 is suitable or not (step 2260). If not suitable then the sponsors A, B depress the registration button 1470. The information service unit 1000 registers the contract condition information in the contract condition information table 720 (step 2270) according to the button pressed. When the sponsors A, B decide the contract condition information in step 2260 is not suitable, the process returns to step 2240 to change the contract condition information.

By registering the trial basic information and contract conditions in advance as in the above process, the trial sites can select the desired trial and contract conditions from the applicable information. Also, the contract condition calculation unit 1010 automatically calculates conditions suitable for selection by the trial site so that the trouble of the sponsors themselves setting the contact conditions can be eliminated.

FIG. 23 is a flow chart showing the procedure for the contract confirmation process.

When the contract confirmation process 2160 is executed, the contract confirmation interface 1600 shown in FIG. 16 appears (step 2300). The sponsors A, B view the subscribing trial sites entry area 1610 and decide if there are competing subscription or not from the trial sites subscribing to the contract trial site conditions (step 2310). If there is competition, then the sponsors A, B depress the rival cancellation button 1620 (step 2320). When this rival cancellation button is depressed, the subscription rival calculation unit 1020 refers to the site rating information table 900, and eliminates competing trial sites (step 2330), and redisplays the results on the contract confirmation interface 1600.

The sponsors A, B next decide if the contract with the subscribing trial sites displayed in the contract confirmation interface 1600 is suitable or not (step 2340). If suitable then the sponsors A, B depress the decision button 1630 (step 2350). When the confirmation button 1630 is depressed, the information service unit 1000 registers the confirmed contract information in the comfirmed contract information table 800 (step 2360), and the process terminates (step 2370). If there is no competition among subscribing trial sites in step 2310, then the process proceeds to step 2350.

Providing an subscription rival calculation unit 1020 allows automatically eliminating competition after checking the rating information, when there is a deluge of applications from trial sites subscribing to a certain contract condition, and eliminates the task of the sponsors themselves eliminating competing sites.

FIG. 24 is a flow chart showing the overall procedure in the process on the trial site side in the clinical trial contract support system.

When the trial sites a, b, c use the terminal 300 to access the clinical trial contract support system (step 2400), the information service unit 1000 refers to the trial site information table 620, and decides whether or not the trial site information was registered or not (step 2410). In step 2410, when the trial site information was registered, then the trial site information registration interface 1200 appears as shown in FIG. 12, urging the trial sites a, b, c to enter the trial site information. When the trial sites a, b, c depress the registration button 1290, the information service unit 1000 terminates the process (step 2420) after registering the trial site information in the trial site information table 620. The user authentication is then executed (step 2430).

In step 2410, user authentication is executed (step 2430) when registration of the trial site information is complete. When user authentication has failed in step 2410, the process terminates (step 2480). When user authentication has succeeded in step 2430, menu selection can be performed (step 2440).

In step 2440, when the contract subscription menu was selected, the contract subscription process is executed (step 2450) and the process returns to step 2440. When the trial results information registration menu was selected in step 2440, the trial results information registration interface 1700 appears as shown in FIG. 17 (step 2460) and the process returns to step 2440. When the trial subjects statistic information registration menu was selected in step 2140, then the trial subjects statistic information registration interface 1800 appears (step 2470), and the process returns to step 2440. When the end menu was selected in step 2440, then the process terminates (step 2480). The contract subscription process is described in detail next using FIG. 25.

The above process allows the trial site to select a desired trial and contract conditions from the pre-registered trial information and contract conditions. Moreover by managing the trial subjects statistic information, the trial sites can impress the sponsor with their site's capability to perform trials. Further, by managing the result information from trials that were actually performed, the information from responses from competing trial sites can be utilized as evaluation information when entering into a contract.

FIG. 25 is a flow chart showing the sequence in the contract subscription process.

When the contract subscription process 2450 is executed, the contract subscription interface 1500 shown in FIG. 15 appears (step 2500). The trial sites a, b, c decide if there is a desired item among the contract condition displayed on the contract subscription interface 1500 (step 2510), and the process terminates if there are no desired contract conditions (step 2570).

If in step 2510, the trial sites a, b, c find a desired contract condition, and if they wish to view detailed information relating to the trial, then trial sites a, b, c depress the detailed information button 1510. The information service unit 1000 displays detailed information (step 2530) relating to the trial if the detailed information button 1510 is pressed. The interface for displaying the information resembles the trial information registration interface 1300 shown in FIG. 13. The detailed display relating to the trial terminates, and to select a desired contract condition the trial sites a, b, c next enter a check in the contract condition checkbox area 1520 (step 2540), and depress the subscription button 1530 (step 2550). The information service unit 1000 then registers the applicable conditions and the matching trial site into the confirmed contract information table 800 (step 2560). In step 2510, the trial sites a, b, c find the desired contract conditions, and if not wishing to view the detailed information on the trial, next proceeds to step 2540 and select the desired contract conditions.

The above process allows the trial site to select a desired trial and contract conditions from the pre-registered trial information and contract conditions.

Second Embodiment

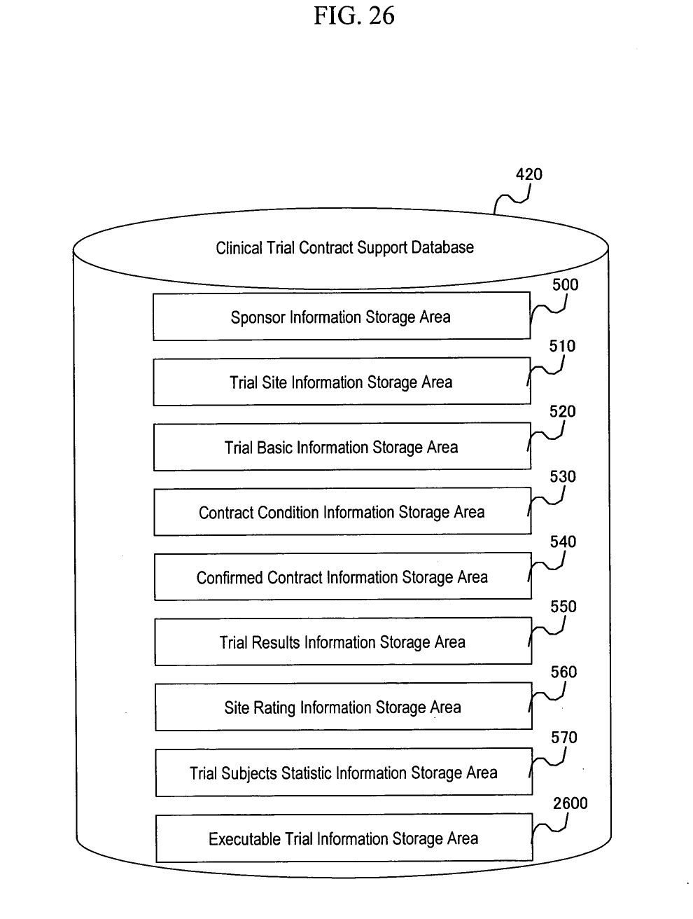

FIG. 26 is a block diagram showing the table area for storing the clinical trial contract support database in the second embodiment of the clinical trial contract support system of this invention.

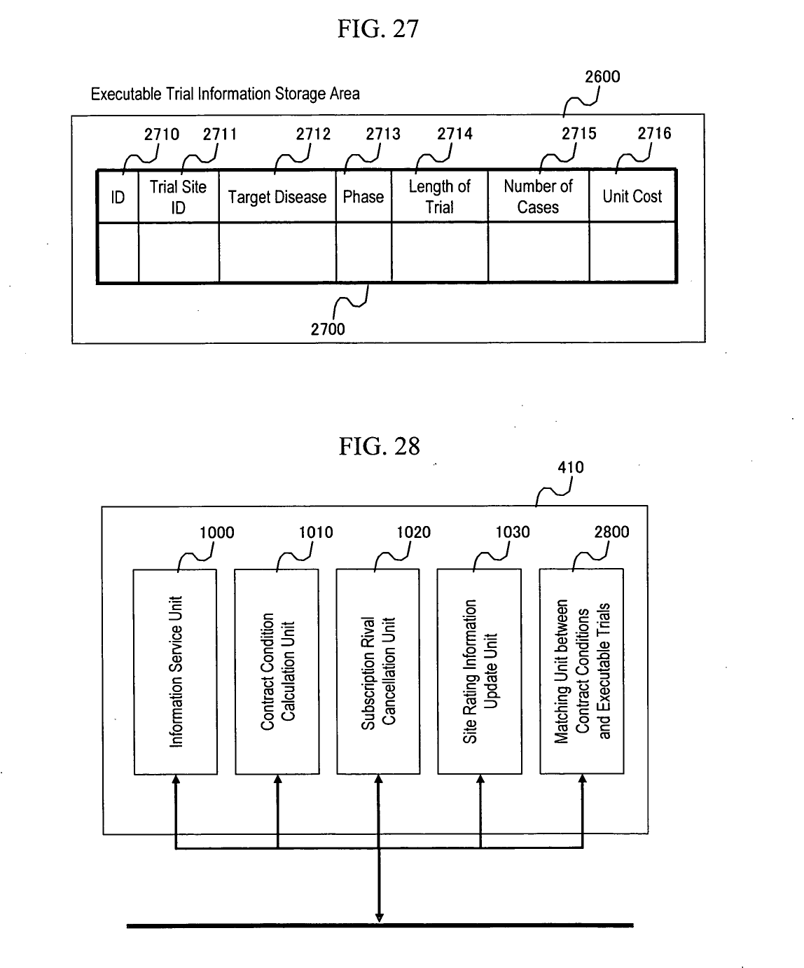

The reference numeral 2600 is an executable trial information storage area for storing information on a desired trial. The executable trial information storage 2600 is described using FIG. 27. Using this type of structure of course allows the clinical trial contract support system 440 of this invention to acquire information relating to the trial that the sponsors A, B wish to request. The trial sites a, b, c can also acquire and manage information relating to a desired trial.

If the trial site registers the desired trial information and contract conditions in advance, then the above embodiment allows the trial site to select the best trial among those trials registered by the sponsor and establish a contract for that trial.

FIG. 27 is a drawing of the table stored in the executable trial information storage area. The reference numeral 2700 is the executable trial information table stored in the executable trial information storage area 2600; reference numeral 2710 is an ID area for managing the primary key of the executable trial information table 2700; reference numeral 2711 is a trial site ID area for managing the foreign key to the trial site information table 620; reference numeral 2712 is a target disease name area for managing the desired target disease name by the trial site controlled in trial site ID area 2711; reference numeral 2713 is a phase area for managing the phase desired by the trial site; reference numeral 2714 is a trial length of trial area for managing the period of the trial desired by the trial site; reference numeral 2715 is a number of cases areas for managing the number of cases desired by the applicable trial site; reference numeral 2716 is a unit cost area for managing the case unit cost desired by the applicable trial site.

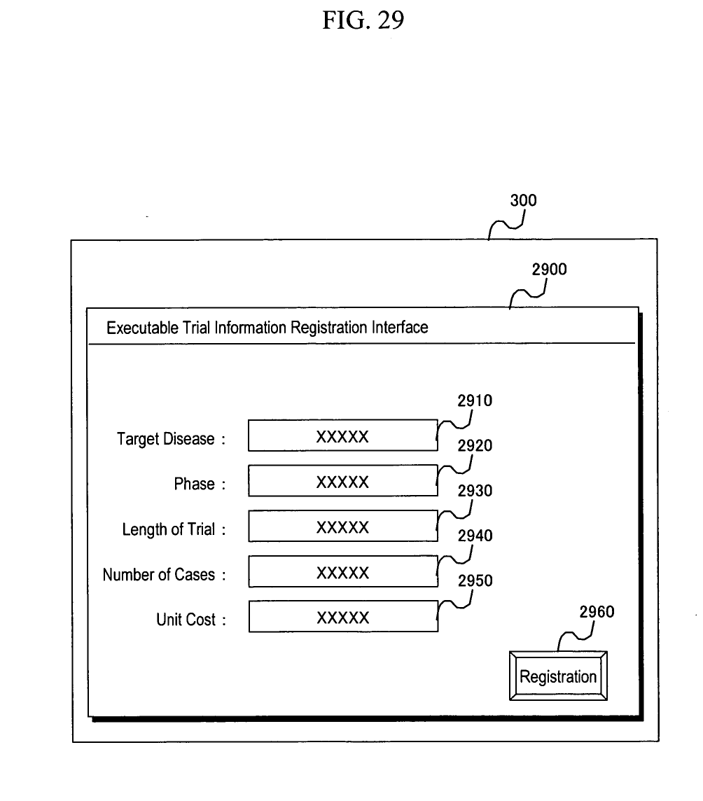

The interface for registering information into the executable trial information table 2700 is described in detail using FIG. 29.

By utilizing this type of structure, the clinical trial contract support system 440 of this invention can acquire and manage information relating to the desired trial from the trial sites, a, b, c. If the desired trial information and contract conditions are registered in advance, then the trial site can select and establish a contract for an ideal trial from among the trials registered by the sponsor, by managing the information as described above.

FIG. 28 is a block diagram showing in detail the structure of the process and information service unit of the second embodiment of this invention. The reference numeral 2800 is a matching unit between contract condition and executable trials for referring to the contract condition information table 720 and the executable trial information table 2700, and matching the information. The matching unit between contract conditions and executable trials 2800 starts up when contract confirmation processing was performed. The matching unit between contract condition and executable trials 2800 matches the information in the contract condition information table 720 with information in the executable trial information table 2700, and extracts those trial sites that fulfill the contract conditions and registers that trial site information in the confirmed contract information table 800.

By including this type of unit, the trial site can match its pre-registered desired trial information and contract conditions, with the trial information and contract conditions registered by the sponsor, and therefore allow establishing a trial contract with ideal contract conditions for both the trial site and the sponsor.

FIG. 29 is a drawing showing the interface for registering the executable trial information. The reference numeral 2900 is an executable trial registration interface for registering information into the executable trial information table 2700; reference numeral 2910 is a target disease entry area for entering the desired target disease name into the target disease area 2712; reference numeral 2920 is a phase entry area for entering the desired phase into the phase area 2713; reference numeral 2930 is a length of trial entry area for entering the desired trial period into the length of trial area 2714; reference numeral 2940 is a number of cases entry area for entering the desired number of cases into the number of cases area 2715; reference numeral 2950 is a unit cost entry area for entering the desired unit cost into the unit cost area 2716; and the reference numeral 2960 is a registration button for registering the above information into the clinical trial contract support database 420.

The trial sites a, b, c utilize the above interface to enter the information on the desired trial, and the information service unit 1000 registers the applicable information into the executable trial information table 2700 when the registration button 2960 is pressed. If the trial sites a, b, c utilize this type of interface to register the desired trial conditions and contract conditions in advance, then the trial sites can select the best trial from among those registered by the sponsors.

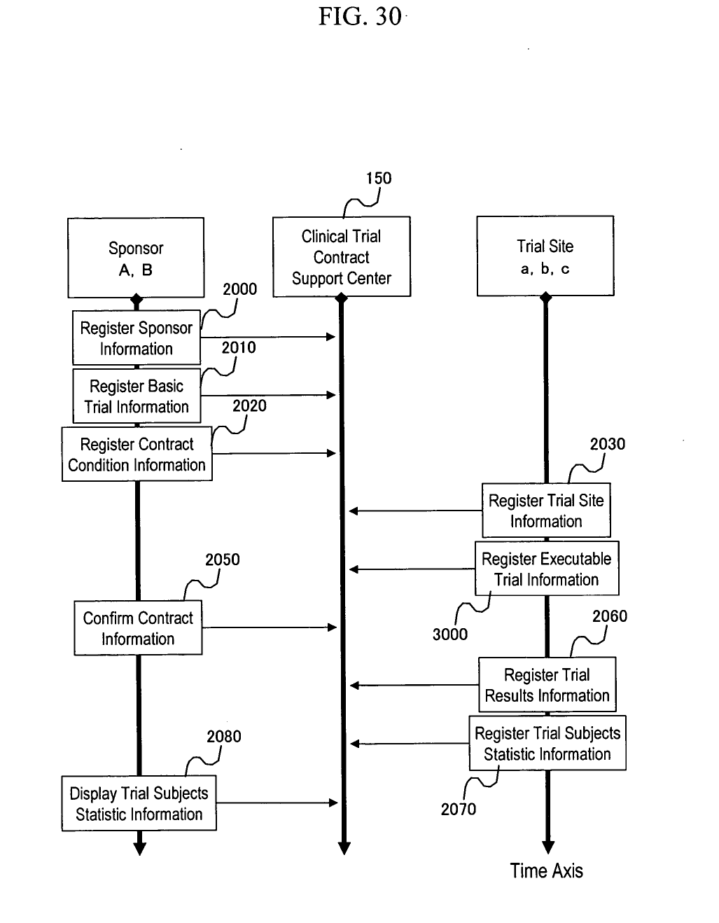

FIG. 30 is a drawing showing the operation of the clinical trial contract support center of the second embodiment of this invention.

The sponsors A, B first of all register the sponsor information into the clinical trial contract support center 150, and acquire access rights to the clinical trial contract support system of this invention (step 2000). Next, the sponsors register the trial basic information they want to request, into the clinical trial contract support center 150 (step 2010), and also register the contract condition information generated based on that trial basic information (step 2020) and complete registration of the trial information.

After completing registration of the trial information, the trial sites a, b, c first of all register their own trial site information into the clinical trial contract support center 150, and acquire access rights to the clinical trial contract support system of this invention (step 2030). The trial sites next register information relating to the desired trial to execute (step 3000). At this point, only registration is performed and the contract is not yet confirmed. The step 3000 may be executed prior to the step 2010 and the step 2020.

The sponsors A, B confirm the contract (step 2050) at the approximate point in time that contract condition was performed, and a contract between the sponsors A, B and the trial sites a, b, c is established according to the confirmed information. The trial sites a, b, c that received the order for a trial, promptly start the trial, and register the result information (step 2060) when the trial is complete. The trial contract support center updates the rating information based on the result information, and prepares for competing applications for a new contract.

On the other hand, in order to enhance the appeal of their own institution in terms of its ability to perform trials, the trial sites a, b, c enter trial subjects statistic information in the clinical trial contract support center 150 (step 2070). The step 2070 need not be implemented after the step 2060, and the trial site information in step 2030 can be executed any time if registration was completed.

In order to find the best trial site to request performing a trial, the sponsors A, B, access the clinical trial contract support center 150, display the trial subjects statistic information (step 2080), and acquire the latest information on the trial sites. The step 2080 need not be implemented after the step 2050, and the trial sponsor information in step 2000 can be executed any time if registration was completed.

In this embodiment if the trial site pre-registers its desired trial information and contract conditions, and the sponsor pre-registers its desired trial information and contract conditions, then the clinical trial contract support system can match the applicable information so that the clinical trial contract support system can establish a trial contract with ideal contract conditions for both the trial site and the sponsor.

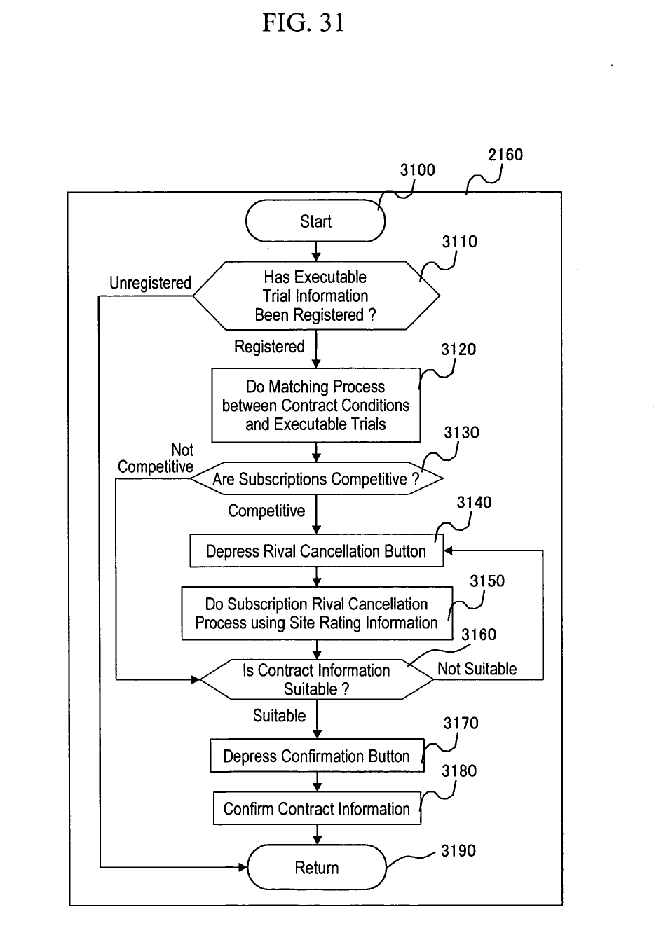

FIG. 31 is a flow chart showing in detail the procedure for confirming the contract in the second embodiment of this invention.

When the contract confirmation process 2160 is executed (step 3100), a search is first made of the executable trial information table 2700, and a decision made whether or not there is registered executable trial information (step 3110). In step 3110, the matching unit between contract conditions and executable trials 2800 starts up when registration was completed. The matching unit between contract conditions and executable trials 2800 then matches the information in the contract condition information table 720 with the information in the executable trial information table 2700, extracts the trial sites that fulfill the contract conditions, and registers information on those trial sites in the confirmed contract information table 800 (step 3120). The contract confirmation interface 1600 then appears.

The sponsors A, B view the subscribing trial sites entry area 1610 and decide if there are competing subscriptions from the trial sites subscribing to the contract trial site conditions (step 3130). If there are competing subscriptions, then the sponsors A, B depress the rival cancellation button 1620 (step 3140). When this rival cancellation button is depressed, the subscription rival calculation unit 1020 refers to the site rating information table 900, eliminates competing trial sites (step 3150), and redisplays the results on the contract confirmation interface 1600. The sponsors A, B next decide if the contract with the subscribing trial sites displayed in the contract confirmation interface 1600 is suitable or not (step 3160). If suitable then the sponsors A, B depress the confirmation button 1630 (step 3170). When the confirmation button 1630 is depressed, the information service unit 1000 registers the confirmed contract information in the confirmed contract information table 800 (step 3180), and the process terminates (step 3190).

In step 3110, if there is no registered executable trial information then the process terminates (step 3190). If there is no competition among subscribing trial sites in step 3130, then the process proceeds to step 3160.

If the trial site registers the desired trial information and contract conditions and the sponsor also registers the requested trial information and trial conditions that the sponsor, then the clinical trial contract support system matches the applicable information so that a trial contract with ideal contract conditions is established. for both the trial site and the sponsor.

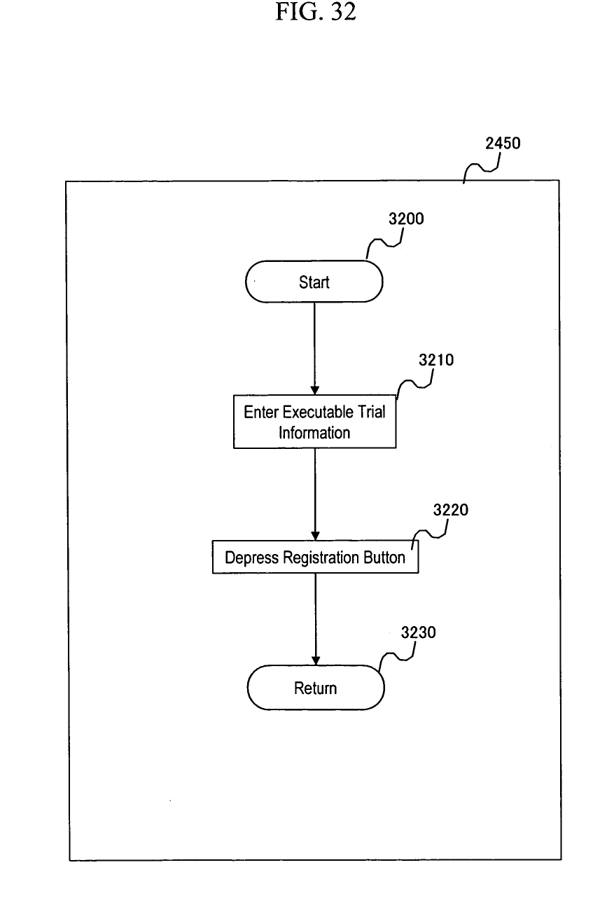

FIG. 32 is a flow chart showing the detailed procedure for registering the contract in the second embodiment of this invention.

When the contract subscription process 2450 is executed, the executable trial information registration interface 2900 appears as shown in FIG. 29 (step 3200). The trial sites a, b, c utilize the executable trial information registration interface 2900 to enter information relating to the desired trial to execute (step 3210) and when the sites a, b, c depress the registration button 2960 (step 3220), the information service 1000 registers the desired trial to execute in the executable trial information table 2700, and the process terminates (step 3230).

If the trial sites register in advance the desired trial information and contract conditions, then this type of process allows the trial sites to select the best trial from among the trial registered by the sponsor and form a contract.

What is claimed is:

1. A clinical trial information processing system containing a database including a sponsor information storage area for storing information relating to the sponsor, and a trial site information storage area for storing information relating to the trial site, and a trial basic information storage area for storing trial basic information including information relating to the trial sponsor name, trial target disease name, trial period, total number of cases and total budget and a contract condition information storage area for storing information on trial contract conditions including the trial name, trial period, number of cases and budget, and
a process and information service unit, wherein the process and information service unit executes processing for: distributing information on trial contract conditions registered in the contract condition information storage area, recording applications from trial sites in response to the trial contract conditions that were distributed, and distributing the status of applicant responses to trial contact conditions registered by the trial sponsor.

2. A trial information processing system according to claim 1, wherein multiple conditions with different trial periods and number of cases registered in the trial contract conditions can be selected.

3. A clinical trial information processing system according to claim 2, wherein the process and information service unit performs processing to generate trial contract conditions from the trial basic information stored in the trial basic information storage area.

4. A clinical trial information processing system according to claim 1, wherein the database further includes a site rating information storage area for storing information relating to the rating of the trial site.

5. A clinical trial information processing system according to claim 4, wherein the database also includes a confirmed contract information storage area for storing information relating to conditions in a contract established between the sponsor and the trial site, and a trial result information storage area for storing trial result information including the number of cases actually processed and the trial period required in a completed contract, and
the process and information service unit ranks the trial sites by comparing the trial result information and the corresponding trial contract conditions, and registers that rating information in the site rating information storage area.

6. A clinical trial information processing system according to claim 4, wherein when there are more than the required applications responding to one trial contract condition, the process and information service unit refers to information relating to ratings of the trial sites, and limits the application registrations for trial contract conditions to the required number of trial sites in order of high ratings.

7. A clinical trial information processing system according to claim 1, wherein the database further contains a trial subjects statistic information area for storing trial subjects statistic information including information on the number of trial subjects and disease names usable by the trial site, and
the process and information service unit distributes the trial subjects statistic information registered in the trial subjects statistic information area to the sponsor.

8. A clinical trial information processing system according to claim 1, wherein the database further contains a desired trial information storage area for registering desired trial information including information on the number of cases and the disease name for a trial that the trial site wishes to perform, and
the process and information service unit distributes the desired trial information registered in the desired trial information storage area to the sponsor.

9. A clinical trial information processing system according to claim 8, wherein the process and information service unit matches the trial contract conditions with information on a desired trial, and extracts a registered trial site whose information on a desired trial satisfies the trial contract conditions.

10. A clinical trial information processing method including a database containing a sponsor information storage area for storing information relating to the sponsor, and a trial site information storage area for storing information relating to the trial site, and a trial basic information storage area for storing trial basic information including information relating to the trial sponsor name, trial target disease name, trial period, total number of cases and total budget and a contract information storage area for storing information on trial contract conditions including the trial name, trial period, number of cases and budget, and
a process and information service unit, wherein
the process and information service unit performs the processes of:
receiving trial basic information from the trial sponsor, and storing the applicable information in the trial basic information storage area;
generating trial contract conditions from the trial basic information, and registering the generated trial contract conditions in the contract information storage area;
distributing information on trial contract conditions registered in the contract information storage area to the trial site;
registering applications for the trial from trial sites responding to the distributed trial contract conditions; and
distributing the resulting responses to the trial contract conditions, to the sponsor that registered those conditions.

11. A clinical trial information processing method according to claim 10, with a database further including a confirmed contract information storage area for storing information relating to contract conditions established between the sponsor and the trial site, and a trial result information storage area for storing trial result information containing the number of cases actually performed and the length of the trial period required for a completed trial, wherein
the process and information service unit performs the steps of:
comparing the trial result information with the corresponding contract conditions and rating the trial sites, and
registering that rating information in the site rating information storage area.

12. A clinical trial information processing method according to claim 11,
wherein the process and information service unit performs the steps of:
deciding if more responses than needed were registered for the trial contract conditions, and
when decided that more responses were registered than needed, refers to information for rating the trial sites, and limits the registered responses to the trial contract conditions to the required number in order of high trial site rating.

13. A clinical trial information processing method according to claim 10, wherein the database further includes trial subjects statistic information area containing information on the number of trial subjects and the disease names the trial site is capable of handling in the trial, and
the process and information service unit distributes the trial subjects statistic information registered in a trial subjects statistic information storage area to the sponsor.

14. A clinical trial information processing method according to claim 10, wherein the database further contains a desired trial storage area for registering information on a desired trial including the number of trial subjects and the disease names for the trial that the trial site wants to perform, and
the process and information service unit distributes the information on the desired trial registered in the desired trial storage area, to the sponsor.

15. A clinical trial information processing method according to claim 14, wherein the process and information service unit performs the steps of:
matching the trial contract conditions with information on a desired trial, and extracts a registered trial site whose information on a desired trial satisfies the trial contract conditions.
